(19) United States
(12) Patent Application Publication
(10) Pub. No.: US 2026/0227175 A1
(43) Pub. Date: Aug. 6, 2026

(54) HIGH-PRECISION MEASUREMENT SYSTEM AND METHOD FOR POSE OF SIX-DEGREE-OF-FREEDOM PARALLEL MECHANISM

(71) Applicants: XI'AN INSTITUTE OF OPTICS AND PRECISION MECHANICS OF CAS, Xi'an (CN); XINJIANG ASTRONOMICAL OBSERVATORY, CAS, Urumqi (CN)

(72) Inventors: Shangmin Lin, Xi'an (CN); Hu Wang, Xi'an (CN); Yu Jin, Xi'an (CN); Yunqiang Lai, Xi'an (CN); Yaoke Xue, Xi'an (CN); Meiying Liu, Xi'an (CN); GULJAINA Kazezkhan, Urumqi (CN); Na Wang, Urumqi (CN); Qian Xu, Urumqi (CN)

(21) Appl. No.: 19/184,941

(22) Filed: Apr. 21, 2025

(30) Foreign Application Priority Data
Feb. 6, 2025 (CN) 202510134014.0

(51) Int. Cl. G01B 11/00; G01B 11/03; G01B 11/26; G06T 7/80

(52) U.S. Cl. CPC G01B 11/005; G01B 11/03; G01B 11/26; G06T 7/80

(57) ABSTRACT

A high-precision measurement system and method for the pose of a six-degree-of-freedom parallel mechanism, comprising a laser emission standard arranged on a top of a parallel mechanism fixed platform; an array light spot feature target component arranged above the laser emission standard; a parallel mechanism moving platform, wherein the array light spot feature target component is arranged at a bottom of the parallel mechanism moving platform, and the four corners of the bottom of the parallel mechanism moving platform are fixedly connected to the top of the parallel mechanism fixed platform via a six-degree-of-freedom parallel mechanism structure; and a feature detection and recognition component arranged at a bottom of the array light spot feature target component, which is used to recognize the light spot information and target feature information. The invention reduces the processing of redundant data, and shortens the measurement cycle, ensuring fast measurement.

### TECHNICAL FIELD

The invention relates to the technical field of measuring equipment, and in particular to a high-precision measurement system and method for the pose of a six-degree-of-freedom parallel mechanism.

### BACKGROUND ART

Large-aperture omnidirectional movable radio telescope antennas typically operate in open-air environments. Due to the fact that the antenna structure is primarily composed of metal materials such as steel, it is susceptible to environmental loads such as gravity, temperature, wind, rain, and snow. These factors can cause deformation in the shape of the antenna's main reflector and the supporting structure of the sub-reflector, leading to a degradation in the surface accuracy of the reflector and misalignment of the microwave optical path. This misalignment results in a loss of antenna gain, pointing errors, and a reduction in the sensitivity of the antenna system. Therefore, it is necessary to install an adjustment mechanism between the sub-reflector and its supporting structure. This mechanism adjusts the position and orientation (pose) of the sub-reflector to actively correct the relative positions of the focal points of the main and sub-reflectors and the phase center of the feed, thereby compensating for defocus errors caused by structural deformation.

For high-precision antenna systems, especially large-aperture omnidirectional movable radio telescope antennas, the sub-reflector has a large diameter, significant weight, and requires substantial adjustments across multiple degrees of freedom. High-precision radio telescope antennas often employ a six-degree-of-freedom parallel mechanism to adjust the pose of the sub-reflector. This mechanism offers high stiffness, compact structure, high precision, and the ability to adjust multiple degrees of freedom.

Large-aperture omnidirectional movable radio telescope antennas are often exposed to complex outdoor environments (gravity, temperature, wind, rain, snow), which introduce numerous factors that can cause motion errors in the sub-reflector adjustment mechanism. The mechanisms behind these errors are complex. Over time, the mechanical transmission system of the electric cylinders and the hinges in the sub-reflector adjustment mechanism may experience wear, leading to increased hinge clearance and reduced transmission accuracy of the electric cylinders. Temperature loads can also cause thermal deformation in components such as electric cylinders and hinges, resulting in deviations between the output pose of the sub-reflector adjustment mechanism and the motor displacement. Additionally, since the sub-reflector adjustment mechanism is mounted on the antenna and subjected to heavy loads, its force characteristics change as the antenna's main reflector moves in elevation. Consequently, the end-effector pose error varies with the antenna's elevation angle, affecting the motion accuracy of the sub-reflector adjustment mechanism across all dimensions. This results in pose errors, preventing the sub-reflector from achieving the required pose accurately, thereby impacting the overall mission. Real-time or quasi-real-time high-precision measurement of the six-degree-of-freedom pose of the sub-reflector adjustment mechanism's moving platform is crucial for improving the motion accuracy of the sub-reflector adjustment mechanism.

Currently, laser trackers and similar equipment are often used to calibrate the sub-reflector adjustment mechanism. However, these measurement methods are slow and cannot be installed on the antenna's sub-reflector for real-time measurement of the six-degree-of-freedom pose. They are typically only used for geometric error calibration. If real-time or quasi-real-time high-precision measurement of the six-degree-of-freedom pose of the parallel mechanism could be achieved, closed-loop control or self-calibration could be implemented, reducing pose deviations caused by non-geometric errors in the sub-reflector adjustment mechanism.

The parallel adjustment mechanism for the sub-reflector of large-aperture antennas is a critical component for adjusting the pose of the optical system in large astronomical telescopes. Such large-scale six-degree-of-freedom pose adjustment systems require more precise, real-time (on the order of seconds) pose measurements to provide accurate feedback for real-time motion adjustments.

Conventional and mature measurement technologies, such as laser trackers and laser scanners, can determine the pose of a moving target within a few seconds. These systems often achieve pose accuracy on the order of tens of micrometers within a meter-level range. However, they have certain requirements for the measurement environment, are not suitable for long-term operation, and have high equipment and maintenance costs. Additionally, the size of these devices is relatively large, and their pose measurement accuracy is limited. Laser trackers also require the installation of appropriate cooperative targets. Photogrammetry methods, including binocular or multi-camera measurements, can achieve similar levels of accuracy but also have long measurement cycles.

To address the need for high-precision measurement for the pose of six-degree-of-freedom parallel mechanisms, a new pose measurement system and method must be designed, which should enable faster and higher-precision pose measurements on moving targets, facilitating real-time feedback and control for pose adjustment systems.

### SUMMARY OF THE INVENTION

In view of this, the invention aims at the deficiencies in the prior art and proposes a high-precision measurement system and method for the pose of a six-degree-of-freedom parallel mechanism, aiming to solve at least one of the problems raised by the above background technology.

In a first aspect, the invention provides a high-precision measurement system for the pose of a six-degree-of-freedom parallel mechanism, comprising:
a laser emission standard, which is arranged on a top of a parallel mechanism fixed platform;
an array light spot feature target component, which is arranged above the laser emission standard;
a parallel mechanism moving platform, wherein the array light spot feature target component is arranged at a bottom of the parallel mechanism moving platform, and a top of the array light spot feature target component is fixedly connected to the bottom of the parallel mechanism moving platform; the four corners of the bottom of the parallel mechanism moving platform are fixedly connected to the top of the parallel mechanism fixed platform via a six-degree-of-freedom parallel mechanism structure;
a feature detection and recognition component, which is arranged at a bottom of the array light spot feature target component, and a detection end of the feature detection and recognition component is oriented toward the array light spot feature target component; the feature detection and recognition component is used to recognize the light spot information and target feature information on the array light spot feature target component.

In some embodiments, the laser emission standard comprises:
two symmetrically arranged bases, and bottoms of the two bases are fixedly connected to the top of the parallel mechanism fixed platform;
a support frame, which is arranged on a top of the two bases, and tops of the two bases are fixedly connected to a bottom of the support frame;
a support base plate, which is arranged inside the support frame, and a side wall of the support base plate is fixedly connected to an inner wall of the support frame;
a reflector, which is arranged on a top of the support base plate, and a mounting end of a bottom of the reflector is fixedly connected to the top of the support base plate; the support base plate coincides with an axis of the reflector;
a laser emission component, which is arranged on the top of the support base plate, and a mounting end at a bottom of the laser emission component is fixedly connected to the top of the support base plate; the top of the support base plate is provided with at least one laser emission component, and the laser emission standard can emit N non-parallel laser beams via the laser emission component, wherein N≥3; the laser emission component is a laser module that emits at least three laser beams individually or a beam splitter laser that can emit at least three laser beams.

In some embodiments, the array light spot feature target component comprises:
a target board, the top of which is fixedly connected to the bottom of the parallel mechanism moving platform; a bottom of the target board is provided with M feature marking points, wherein M≥3, and the positions of the feature marking points on the target board are known;
at least one laser emitter, and a mounting end of the laser emitter is fixedly connected to the bottom of the target board; the laser emitter is a laser module that emits at least three laser beams individually or a beam splitter that can emit at least three laser beams.

In some embodiments, the laser module comprises a laser, a laser sleeve, fixing screws, and adjusting screws; the laser module is fixedly connected to the top of the support base plate or the bottom of the target board via a plurality of the fixing screws and the adjusting screws; an inside of the laser sleeve is installed with a laser;
the laser beam emitted by the laser emission standard and the array light spot feature target component is calibrated in advance and defined as a spatial straight line by fitting.

In some embodiments, the feature detection and recognition component comprises:
a support holder;
a camera detector, which is arranged on a top of the support holder, and the top of the support holder is detachably connected to the camera detector; a shooting end of the camera detector is provided with an optical lens, and the field of view of the optical lens can cover the target board feature information of the array light spot feature target component, as well as the light spot where the laser emitted by the laser emission standard with the target board, and the light spot where the laser emitted by the array light spot feature target component itself intersects with the target board through the light beam reflected by the reflector.

In some embodiments, the laser emission standard projects at least three laser beams that irradiate a planar area at the bottom of the target board in different poses and at least three complete laser spots are formed, and the centroids of the three intersecting laser spots are not collinear.

In a second aspect, the invention provides a high-precision measurement method for the pose of a six-degree-of-freedom parallel mechanism, including the following steps:
step 1: first calibrating and fitting the three-dimensional coordinate equation of the laser beam space; at least three groups of laser emission units emit three laser beams through the laser; the equivalent linear equation of the emitted laser beam is as follows:

$$L 1 : xj 1 = Xj 10 + tj 1 * Xj 1 ;$$

$$yj 1 = Yj 10 + tj 1 * Yj 1 ;$$

$$zj 1 = Zj 10 + tj 1 * Zj 1 ;$$

$$L 2 : xj 2 = Xj 20 + tj 2 * Xj 2 ;$$

$$yj 2 = Yj 20 + tj 2 * Yj 2 ;$$

$$zj 2 = Zj 20 + tj 2 * Zj 2 ;$$

$$L 3 : xj 3 = Xj 30 + tj 3 * Xj 3 ;$$

$$yj 3 = Yj 30 + tj 3 * Yj 3 ;$$

$$zj 3 = Zj 30 + tj 3 * Zj 3 ;$$

in the above formulas: L1, L2, L3 are the equivalent spatial straight line equations of the three laser beams emitted by the three lasers;
(xj1, yj1, zj1) is the coordinate of any point on the laser beam spatial straight line L1 in space;
(xj2, yj2, zj2) is the coordinate of any point on the laser beam spatial straight line L2 in space;
(xj3, yj3, zj3) is the coordinate of any point on the laser beam spatial straight line L3 in space;
Xj10, Yj10, Zj10, Xj1, Yj1, Zj1, Xj20, Yj20, Zj20, Xj2, Yj2, Zj2, Xj30, Yj30, Zj30, Xj3, Yj3, and Zj3 are the constants of the straight line equation; tj1, tj2, and tj3 are the variable parameters of the straight line equation;
step 2: pre-recognizing or calibrating the feature edge or feature point of a specific plane area of the target to be measured, and obtaining the relative position relationship of the feature edge or feature point; the feature point is any position of the plane area to be measured;
step 3: using the relative position relationship of the plane corner points or edge features calibrated in step 2, the feature detection and recognition component directly photographs the target plane to be measured, and calibrating the camera intrinsic parameters and the camera optical system distortion parameters by using the known corner point and edge feature position relationship and the two-dimensional image captured by the camera;
steps to solve detector distortion based on the double straight line principle:
1) defining the camera lens distortion as:

$$\{ \begin{matrix}{x}_{u} - {C}_{x} = ( {x}_{d} - {C}_{x} ) ( 1 + {λ}_{1} {r}_{d}^{2} + {λ}_{2} {r}_{d}^{4} + … ) \\ {y}_{u} - {C}_{y} = ( {y}_{d} - {C}_{y} ) {( 1 + {λ}_{1} {r}_{d}^{2} + {λ}_{2} {r}_{d}^{4} + … )}^{}\end{matrix}$$

in the formula, (xᵤ, yᵤ) is the undistorted image point; (x_{d}, y_{d}) is the corresponding distorted image point; λ₁ and λ₂ are the distortion coefficients; (C_{X}, C_{y}) is the distortion center;
2) defining the ideal straight line equation of any straight line on the object to be measured in the image as:

$${ax}_{u} + {by}_{u} + c = 0$$

in the formula, a, b, and c are the parameters of the straight line equation;
3) combining steps 1-2 to get:

$${x}_{d}^{2} + {y}_{d}^{2} + {x}_{d} e + {y}_{d} f + g = 0$$

in the formula,

$$\{ \begin{matrix}e = \frac{a}{c λ} - 2 {C}_{x} \\ f = \frac{b}{c λ} - 2 {C}_{y} \\ g = {C}_{x}^{2} + {C}_{y}^{2} - \frac{a}{c λ} {C}_{x} - \frac{b}{c λ} {C}_{y} + \frac{1}{λ}\end{matrix}$$

4) using the feature detection and recognition component to extract the edge curve (distorted line) corresponding to the ideal straight line on the target image; for any edge curve, (x_{d,i}, y_{d,i}), i=1, 2, . . . , n is any point on the edge; satisfying the formula in step 3 to get:

$$\begin{matrix}[ \begin{matrix}{x}_{d , 1} & {y}_{d , 1} & 1 \\ {x}_{d , 2} & {y}_{d , 2} & 1 \\ ⋮ & ⋮ & ⋮ \\ {x}_{d , n} & {y}_{d , n} & 1\end{matrix} ] \\ {︸}_{M}\end{matrix} \begin{matrix}[ \begin{matrix}e \\ f \\ g\end{matrix} ] \\ {︸}_{X}\end{matrix} = \begin{matrix}[ \begin{matrix}- {x}_{d , 1}^{2} - {y}_{d , 1}^{2} \\ - {x}_{d , 2}^{2} - {y}_{d , 2}^{2} \\ ⋮ \\ - {x}_{d , n}^{2} - {y}_{d , n}^{2}\end{matrix} ] \\ {︸}_{N}\end{matrix} MX = N$$

5) using the least square method to solve the distortion coefficients e, f and g in step 4, and using the obtained distortion coefficients to correct the image distortion;
step 4: defining a two-dimensional coordinate system by using the plane image of the target board obtained by the feature detection and recognition component, selecting the intersection formed by the two edges of the specific plane as the two-dimensional coordinate origin, and defining the straight line formed by one edge as the X-axis; drawing a perpendicular line to the defined X-axis as the Y-axis of the two-dimensional coordinate system, determining another edge point as the next straight line of the two-dimensional coordinate system, and using this two-dimensional coordinate system to define the two-dimensional position information of the remaining feature points respectively; the subsequent measurement quasi-coordinate system definition remains unchanged; if a two-dimensional coordinate system is defined for a plane feature point, selecting two feature points, one point is defined as the two-dimensional coordinate origin, and the connecting line is used as the X-axis; drawing a perpendicular line to the defined X-axis as the Y-axis of the two-dimensional coordinate system, and determining the coordinates of the third feature point of the three feature points in the two-dimensional coordinate system;
step 5: under the two-dimensional coordinate system established in step 4, using image processing technology, according to the image obtained by the feature detection and recognition component, determining the location of the centroid of the light spot formed by the intersection of the three laser beams emitted by the laser on the plane area of the target to be measured; the two-dimensional coordinates based on the target board system coordinate system are recorded as:

$$P 01 : ( x 01 , y 01 ) , P 02 : ( x 02 , y 02 ) , P 03 : ( x 03 , y 03 ) ;$$

step 6: using the equivalent space straight line equation established in step 1 and the position coordinates obtained in step 5, and the principle that the lengths of the same space line segments are equal in coordinate systems with different proportional factors, calculating the spatial coordinates of the centroid of the light spots where the laser beams emitted by the three lasers intersect the plane area of the target to be measured; the spatial coordinates are defined as the spatial coordinates of the centroid of the three light spots of the target to be measured, which are recorded as: Pq01: (xq01, yq01, zq01), Pq02: (xq02, yq02, zq02), Pq03: (xq03, yq03, zq03);
the specific calculation process is as follows:
according to the principle that the length of space line segments is equal:

$$( xq 01 - xq 02 ) \hat{} 2 + ( yq 01 - yq 02 ) \hat{} 2 + ( zq 01 - zq 02 ) \hat{} 2 = ( x 02 - x 01 ) \hat{} 2 + ( y 02 - y 01 ) \hat{} 2 ;$$

$$( xq 03 - xq 02 ) \hat{} 2 + ( yq 03 - yq 02 ) \hat{} 2 + ( zq 03 - zq 02 ) \hat{} 2 = ( x 02 - x 03 ) \hat{} 2 + ( y 02 - y 03 ) \hat{} 2 ;$$

$$( xq 03 - xq 01 ) \hat{} 2 + ( yq 03 - yq 01 ) \hat{} 2 + ( zq 03 - zq 01 ) \hat{} 2 = ( x 01 - x 03 ) \hat{} 2 + ( y 01 - y 03 ) \hat{} 2 ;$$

combined with the three laser fitting space straight line equations, the spatial coordinates of any three points in the plane area of the target to be measured based on the laser emission reference coordinate system can be calculated, Pq01: (xq01, yq01, zq01), Pq02: (xq02, yq02, zq02), Pq03: (xq03, yq03, zq03);
step 8: the coordinates of the three light spots in the target board coordinate system are P01: (x01, y01, 0), P02: (x02, y02, 0), and P03: (x03, y03, 0); by using the BURSA principle (a method for coordinate transformation), the coordinates of the common points in the two coordinate systems can be solved to obtain the position translation and attitude deviation in the two coordinate systems;

$$[ \begin{matrix}{X}_{Ti} - {X}_{i} \\ {Y}_{Ti} - {Y}_{i} \\ {Z}_{Ti} - {Z}_{i}\end{matrix} ] = [ \begin{matrix}1 & 0 & 0 & {X}_{i} & 0 & - {Z}_{i} & {Y}_{i} \\ 0 & 1 & 0 & {Y}_{i} & {Z}_{i} & 0 & - {X}_{i} \\ 0 & 0 & 1 & {Z}_{i} & - {Y}_{i} & {X}_{i} & 0\end{matrix} ] * [ \begin{matrix}Δ X \\ Δ Y \\ Δ Z \\ k \\ {ε}_{X} \\ {ε}_{Y} \\ {ε}_{Z}\end{matrix} ]$$

(XTi, YTi, ZTi) are the three-dimensional coordinates of the three light spots in the laser emission reference coordinate system, (Xi, Yi, Zi) are the three-dimensional coordinates based on the target board system coordinate system (Zi=0 is defined); (ΔX, ΔY, ΔZ)) are the position translations of the emission and target coordinate systems, k is the calculation scale factor of the two coordinate systems, and (εX, εY, εZ) are the attitude deviation angles of the emission and target coordinate systems;
step 9: repeating steps 3-8, and using the position translation and attitude deviation angle of the target board coordinate system relative to the emission reference coordinate system solved under different attitudes to obtain the target's three-degree-of-freedom position information and three-degree-of-freedom attitude information;
step 10: defining an edge of the target board as the X-axis of the target board system coordinate system, defining the corner point of this edge and the adjacent edge as the origin, taking the plane of the target board as the XOY plane, and the direction perpendicular to the plane of the target board as the Z-axis to establish the target board system coordinate system;
step 11: defining the laser beams emitted by the three lasers on the target board system as L₅, L₆, L₇, respectively;
step 12: taking the laser beam L₅ as an example, the rotation matrix R and translation matrix T between the target board system coordinate system and the laser emission system coordinate system are obtained by the three-dimensional structured light method to solve the spatial straight line equation of laser beam L₅ in the laser emission system coordinate system:
the conversion relationship between the target board coordinate system and the laser emission system coordinate system is as follows:

$$[ \begin{matrix}{X}_{2} \\ {Y}_{2} \\ {Z}_{2}\end{matrix} ] = R * [ \begin{matrix}{X}_{1} \\ {Y}_{1} \\ {Z}_{1}\end{matrix} ] + [ \begin{matrix}{t}_{1} \\ {t}_{2} \\ {t}_{3}\end{matrix} ]$$

wherein

$$[ \begin{matrix}{X}_{1} \\ {Y}_{1} \\ {Z}_{1}\end{matrix} ]$$

represents the coordinates in the target board coordinate system, and

$$[ \begin{matrix}{X}_{2} \\ {Y}_{2} \\ {Z}_{2}\end{matrix} ]$$

represents the coordinates in the laser emission system coordinate system;
R is a 3×3 rotation matrix, which describes the rotation relationship between the target board coordinate system and the laser emission system coordinate system:

$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

T is the translation vector, which describes the translation relationship from the target board coordinate system to the laser emission system coordinate system:

$$T = [ \begin{matrix}{t}_{1} \\ {t}_{2} \\ {t}_{3}\end{matrix} ]$$

defining the spatial straight line equation L₅ of the laser beam in the target board coordinate system as follows:

$${X}_{1} = {a}_{1} {s}_{1} + {b}_{1}$$

$${Y}_{1} = {c}_{1} {s}_{1} + {d}_{1}$$

$${Z}_{1} = {s}_{1}$$

converting L₅ in the target board coordinate system to the laser emission system coordinate system as follows:

$$[ \begin{matrix}{X}_{2} \\ {Y}_{2} \\ {Z}_{2}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{a}_{1} {S}_{1} + {b}_{1} \\ {c}_{1} {S}_{1} + {d}_{1} \\ {S}_{1}\end{matrix} ] + [ \begin{matrix}{t}_{1} \\ {t}_{2} \\ {t}_{3}\end{matrix} ]$$

converting L₅ in the target board coordinate system to the laser emission system coordinate system as follows:

$${X}_{2} = ( {r}_{11} {a}_{1} + {r}_{12} {c}_{1} + {r}_{13} ) {S}_{1} + ( {r}_{11} {b}_{1} + {r}_{12} {d}_{1} + {t}_{1} )$$

$${Y}_{2} = ( {r}_{21} {a}_{1} + {r}_{22} {c}_{1} + {r}_{23} ) {S}_{1} + ( {r}_{21} {b}_{1} + {r}_{22} {d}_{1} + {t}_{2} )$$

$${Z}_{2} = ( {r}_{31} {a}_{1} + {r}_{32} {c}_{1} + {r}_{33} ) {S}_{1} + ( {r}_{31} {b}_{1} + {r}_{32} {d}_{1} + {t}_{3} )$$

solving the equation of the laser beam L₅ in the laser emission system coordinate system as follows:

$${X}_{2} = {A}_{2} {S}_{1} + {B}_{2}$$

$${Y}_{2} = {C}_{2} {S}_{1} + {D}_{2}$$

$${Z}_{2} = {E}_{2} {S}_{1} + {F}_{2}$$

wherein,

$${A}_{2} = {r}_{11} {a}_{1} + {r}_{12} {c}_{1} + {r}_{13} , {B}_{2} + {r}_{11} {b}_{1} + {r}_{12} {d}_{1} + {t}_{1}$$

$${C}_{2} = {r}_{21} {a}_{1} + {r}_{22} {c}_{1} + {r}_{23} , {D}_{2} + {r}_{21} {b}_{1} + {r}_{22} {d}_{1} + {t}_{2}$$

$${E}_{2} = {r}_{31} {a}_{1} + {r}_{32} {c}_{1} + {r}_{33} , {F}_{2} + {r}_{31} {b}_{1} + {r}_{32} {d}_{1} + {t}_{3}$$

step 13: defining the reflector plane as the plane with Z=0 in the laser emission system coordinate system, then the equation of the spatial straight line after the laser beam L₅ is reflected by the reflector is

$${L}_{5}^{′} :$$

$${X}_{2}^{′} = {X}_{2} = {A}_{2} {S}_{1} + {B}_{2}$$

$${Y}_{2}^{′} = {Y}_{2} = {C}_{2} {S}_{1} + {D}_{2}$$

$${Z}_{2}^{′} = - {Z}_{2} = - ( {E}_{2} {S}_{1} + {F}_{2} )$$

step 14: using the stereo structured light method to solve the equation of the target board plane in the laser emission system coordinate system; the target board plane M₁ is:

$${M}_{1} : {A}_{3} x + {B}_{3} y + {C}_{3} z + {D}_{3} = 0$$

step 15: solving the intersection coordinates P₅(x₅, y₅, z₅) of the laser beam

$${L}_{5}^{′}$$

after being reflected by the reflector and the target board plane M₁;
wherein the intersection point P₅(x₅, y₅, z₅) satisfies the spatial straight line equation of the laser beam

$${L}_{5}^{′} ,$$

$${x}_{5} = {X}_{2}^{′} = {A}_{2} {S}_{1} + {B}_{2}$$

$${y}_{5} = {Y}_{2}^{′} = {C}_{2} {S}_{1} + {D}_{2}$$

$${z}_{5} = {Z}_{2}^{′} = - ( {E}_{2} {S}_{1} + {F}_{2} )$$

substituting x₅, y₅, z₅ into the target plane equation A₃x+B₃y+C₃z+D₃=0:

$${A}_{3} ( {A}_{3} {S}_{1} + {B}_{2} ) + {B}_{3} ( {C}_{2} {S}_{1} + {D}_{2} ) + {C}_{3} ( - {E}_{2} {S}_{1} + {F}_{2} ) ) + {D}_{3} = 0$$

after expansion:

$$( {A}_{3} {A}_{2} + {B}_{3} {C}_{2} - {C}_{3} {E}_{2} ) {S}_{1} + ( {A}_{3} {B}_{2} + {B}_{3} {D}_{2} - {C}_{3} {F}_{2} + {D}_{3} ) = 0$$

after solving the parameter S₁, substituting it into the intersection coordinate formula to get the intersection coordinates:

$${x}_{5} = - \frac{{A}_{2} {k}_{2}}{{k}_{1}} + {B}_{2}$$

$${y}_{5} = - \frac{{C}_{2} {k}_{2}}{{k}_{1}} + {D}_{2}$$

$${z}_{5} = \frac{{E}_{2} {k}_{2}}{{k}_{1}} - {F}_{2}$$

wherein:

$${k}_{1} = {A}_{3} {A}_{2} + {B}_{3} {C}_{2} - {C}_{3} {E}_{2}$$

$${k}_{2} = {A}_{3} {B}_{2} + {B}_{3} {D}_{2} - {C}_{3} {F}_{2} + {D}_{3}$$

step 16: using the stereo structured light method to solve the pose change of the target board under the laser emission system as Δx, Δy, Δz, α, β, γ;
step 17: according to the pose change in step 16, Δx, Δy, Δz, α, β, γ, the rotation matrix R′ and translation matrix T′ representing the pose change of the target board system in the laser emission system coordinate system are:

$${R}^{′} = [ \begin{matrix}cos βcos γ & cos γsin αsin β - cos αsin γ & sin αsin γ + cos αcos γsin β \\ cos βsin γ & cos αcos γ + sin αsin βsin γ & cos αsin βsin γ - cos γsin α \\ - sin β & cos βsin α & cos αcos β\end{matrix} ]$$

$${T}^{′} = [ \begin{matrix}Δ x \\ Δ y \\ Δ z\end{matrix} ]$$

step 18: according to the rotation matrix R′ and translation matrix T′ obtained in step 17, calculating the spatial straight line equation L″₅ of the laser beam L₅ after the pose change: substituting the linear equation (X₂, Y₂, Z₂) of the laser beam L₅ into the rotation and translation formulas:

$$[ \begin{matrix}{X}_{3} \\ {Y}_{3} \\ {Z}_{3}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \cdot [ \begin{matrix}{A}_{2} {S}_{1} + {B}_{2} \\ {C}_{2} {S}_{1} + {D}_{2} \\ {E}_{2} {S}_{1} + {F}_{2}\end{matrix} ] + [ \begin{matrix}Δ x \\ Δ y \\ Δ z\end{matrix} ]$$

the linear equation of the laser beam space after the pose change is:

$${X}_{3} = {A}_{3} {S}_{1} + {B}_{3}$$

$${Y}_{3} = {C}_{3} {S}_{1} + {D}_{3}$$

$${Z}_{3} = {E}_{3} {S}_{1} + {F}_{3}$$

wherein:

$${A}_{3} = {r}_{11} {A}_{2} + {r}_{12} {C}_{2} + {r}_{13} {E}_{2} , {B}_{3} = {r}_{11} {B}_{2} + {r}_{12} {D}_{2} + {r}_{13} {F}_{2} + Δ x$$

$${C}_{3} = {r}_{21} {A}_{2} + {r}_{22} {C}_{2} + {r}_{23} {E}_{2} , {D}_{3} = {r}_{21} {B}_{2} + {r}_{22} {D}_{2} + {r}_{23} {F}_{2} + Δ y$$

$${E}_{3} = {r}_{31} {A}_{2} + {r}_{32} {C}_{2} + {r}_{33} {E}_{2} , {F}_{3} = {r}_{31} {B}_{2} + {r}_{32} {D}_{2} + {r}_{33} {F}_{2} + Δ z$$

step 19: the spatial straight line equation of the laser beam L″₅ after being reflected by the reflector becomes L′″₅:

$${X}_{3} = {A}_{3} {S}_{1} + {B}_{3}$$

$${Y}_{3} = {C}_{3} {S}_{1} + {D}_{3}$$

$${Z}_{3} = - {E}_{3} {S}_{1} - {F}_{3}$$

step 20: after the pose change of the target board plane, the plane equation of the target board plane M₁ in the laser emission system coordinate system becomes:

$${M}_{1}^{′} : {A}_{3}^{′} x + {B}_{3}^{′} y + {C}_{3}^{′} z + {D}_{3}^{′} = 0$$

wherein:

$$[ \begin{matrix}{A}_{3}^{′} \\ {B}_{3}^{′} \\ {C}_{3}^{′}\end{matrix} ] = {R}^{T} \cdot [ \begin{matrix}{A}_{3} \\ {B}_{3} \\ {C}_{3}\end{matrix} ] , {D}_{3}^{′} = {D}_{3} - ( {A}_{3}^{′} Δ x + {B}_{3}^{′} Δ y + {C}_{3}^{′} Δ z )$$

step 21: solving the intersection coordinates

$${P}_{5}^{′} ( {x}_{5}^{′} , {y}_{5}^{′} , {z}_{5}^{′} )$$

of the laser beam L′″₅ and the plane M′₁ as follows:

$${x}_{5}^{′} = - \frac{{A}_{3} {K}_{2}^{′}}{{K}_{1}^{′}} + {B}_{3}$$

$${y}_{5}^{′} = - \frac{{C}_{3} {K}_{2}^{′}}{{K}_{1}^{′}} + {D}_{3}$$

$${z}_{5}^{′} = - \frac{{E}_{3} {K}_{2}^{′}}{{K}_{1}^{′}} - {F}_{3}$$

wherein:

$${K}_{1}^{′} = {A}_{3}^{′} {A}_{3} + {B}_{3}^{′} {C}_{3} - {C}_{3}^{′} {E}_{3}$$

$${K}_{2}^{′} = {A}_{3}^{′} {B}_{3} + {B}_{3}^{′} {D}_{3} - {C}_{3}^{′} {F}_{3} + {D}_{3}^{′}$$

step 22: according to the camera detector, the distance between the laser beam and the light spot on the target board plane after the pose change is ΔL₁;
step 23: combining steps 16 and 21 to solve the intersection coordinates P₅(x₅, y₅, z₅) and

$${P}_{5}^{′} ( {x}_{5}^{′} , {y}_{5}^{′} , {z}_{5}^{′} )$$

before and after the pose change and the distance ΔL₁ in step 23 to get:

$${{Δ {L}_{1} = \{ {[ ( 1 - \frac{{A}_{2} {k}_{2}}{{k}_{1}} + {B}_{2} ) - ( - \frac{{A}_{3} {k}_{2}^{′}}{{k}_{1}^{′}} + {B}_{2} ) ]}^{2} + [ ( C - \frac{{C}_{2} {k}_{2}}{{k}_{1}} + {D}_{2} ) - ( - \frac{{C}_{3} {k}_{2}^{′}}{{k}_{1}^{′}} ) + {D}_{3} ) ]}^{2} + {[ ( \frac{{E}_{2} {k}_{3}}{{k}_{1}} - {F}_{2} ) - ( \frac{{E}_{3} {k}_{1}^{′}}{{k}_{1}^{′}} - {F}_{3} ) ]}^{2} \}}^{\frac{1}{2}}$$

the relationship can be written as:

$${{\{ {[ ( 1 - \frac{{A}_{2} {k}_{2}}{{k}_{1}} + {B}_{2} ) - ( - \frac{{A}_{3} {k}_{2}^{′}}{{k}_{1}^{′}} + {B}_{2} ) ]}^{2} + [ ( C - \frac{{C}_{2} {k}_{2}}{{k}_{1}} + {D}_{2} ) - ( - \frac{{C}_{3} {k}_{2}^{′}}{{k}_{1}^{′}} ) + {D}_{3} ) ]}^{2} + {[ ( \frac{{E}_{2} {k}_{3}}{{k}_{1}^{′}} - {F}_{2} ) - ( \frac{{E}_{3} {k}_{1}^{′}}{{k}_{1}^{′}} - {F}_{3} ) ]}^{2} \}}^{\frac{1}{2}} - Δ {L}_{1} = 0$$

the above relationship can be written as a form containing three unknowns α, β, and γ:

$${F}_{1} ( α , β , γ ) = 0$$

step 24: repeating steps 12-23 to obtain the equations of laser beams L₆, L₇ and ΔL₂, ΔL₃ with respect to α, β, γ:

$${F}_{2} ( α , β , γ ) = 0$$

$${F}_{3} ( α , β , γ ) = 0$$

step 25: transforming the equations in steps 23-24 into:

$$F ( α , β , γ ) = {F}_{1} + {F}_{2} + {F}_{3} = 0$$

step 26: using the Gauss-Newton nonlinear least squares algorithm to solve the angles α, β, γ; finally, obtaining the pose information of the array light spot feature target component relative to the laser emission standard;
step 27: repeating steps 3-26, and using the position translation and attitude deviation angle of the target board coordinate system relative to the emission reference coordinate system solved under different poses to obtain the three-degree-of-freedom position information and three-degree-of-freedom attitude information of the target, and feeding back the six-degree-of-freedom array light spot feature target component pose information, i.e. the parallel mechanism moving platform pose information, to the six-degree-of-freedom parallel mechanism structure in real time for motion adjustment;
step 28: measuring the pose information and converting it into the pose adjustment information of the six-degree-of-freedom parallel mechanism structure:
the parallel mechanism base coordinate system {B} is located on the parallel mechanism fixed platform; the parallel mechanism base coordinate system {B} is the reference datum of other coordinate systems; the moving platform coordinate system {P} is located on the parallel mechanism moving platform; {M} is the laser emission reference coordinate system of the measurement system; {T} is the target board coordinate system; the relative position of the target board coordinate system and the moving platform coordinate system is fixed;
the transformation relationship between coordinate systems is expressed by the homogeneous transformation matrix; the pose transformation relationship from the moving platform coordinate system {P} to the base coordinate system {B} is represented by

$${T}_{\text{?}}^{\text{?}} ;$$

$$\text{?} \text{indicates text missing or illegible when filed}$$

similarly, the pose transformation from the target board coordinate system {T} to the base coordinate system {B} is represented by

$${T}_{\text{?}}^{\text{?}} ;$$

$$\text{?} \text{indicates text missing or illegible when filed}$$

and the pose transformation from the target board coordinate system {T} to the moving platform coordinate system {P} is represented by

$${T}_{\text{?}}^{\text{?}} ;$$

$$\text{?} \text{indicates text missing or illegible when filed}$$

the pose transformation matrix is:

$${T}_{\text{?}}^{\text{?}} = [ \begin{matrix}{R}_{\text{?}}^{\text{?}} & {R}_{\text{?}}^{\text{?}} \\ 0 & 1\end{matrix} ] , {T}_{\text{?}}^{\text{?}} = [ \begin{matrix}{R}_{\text{?}}^{\text{?}} & {R}_{\text{?}}^{\text{?}} \\ 0 & 1\end{matrix} ] , {T}_{\text{?}}^{\text{?}} = [ \begin{matrix}{R}_{\text{?}}^{\text{?}} & {R}_{\text{?}}^{\text{?}} \\ 0 & 1\end{matrix} ] \qquad ( 1 )$$

$$\text{?} \text{indicates text missing or illegible when filed}$$

the above coordinate system transformation relationship satisfies:

$${T}_{T}^{B} = {T}_{P}^{B} {T}_{T}^{P} \qquad ( 2 )$$

combined with the pose transformation matrix, it can be expressed as:

$$[ \begin{matrix}{R}_{P}^{B} & {P}_{P}^{B} \\ 0 & 1\end{matrix} ] = [ \begin{matrix}{R}_{P}^{B} & {P}_{P}^{B} \\ 0 & 1\end{matrix} ] [ \begin{matrix}{R}_{T}^{P} & {P}_{T}^{P} \\ 0 & 1\end{matrix} ] \qquad ( 4 )$$

it can be obtained from formula 2 that:

$${R}_{T}^{B} = {R}_{P}^{B} {R}_{T}^{P} \qquad ( 5 )$$

$${P}_{T}^{B} = {R}_{P}^{B} {P}_{T}^{P} + {P}_{T}^{B} \qquad ( 6 )$$

similarly, in the laser emission reference coordinate system, (5) and (6) can be expressed as

$${R}_{T}^{B} = {R}_{M}^{B} {R}_{T}^{M} \qquad ( 7 )$$

$${P}_{T}^{B} = {R}_{M}^{B} {P}_{T}^{M} + {P}_{M}^{B} \qquad ( 8 )$$

combining formulas (5)-(8) to obtain the rotation matrix and translation matrix of the six-degree-of-freedom parallel mechanism structure:

$${R}_{P}^{B} = {R}_{M}^{B} {{R}_{T}^{M} ( {R}_{T}^{P} )}^{- 1} \qquad ( 9 )$$

$${P}_{P}^{B} = {R}_{M}^{B} {P}_{T}^{M} + {P}_{M}^{B} - {R}_{P}^{B} {P}_{T}^{P} \qquad ( 10 )$$

the measured pose information can be converted into the pose information of the six-degree-of-freedom parallel mechanism structure through formulas (9) and (10), where

$${R}_{T}^{M} and {P}_{T}^{M}$$

are the rotation matrix and translation matrix calculated from the three-degree-of-freedom pose information and the three-degree-of-freedom pose information obtained in step 27,

$${R}_{M}^{B} , {R}_{T}^{P} , {P}_{M}^{B} , and {P}_{T}^{P}$$

are fixed values that can be obtained based on the measurement results of multiple pose points.

Compared with the prior art, the invention has the following beneficial effects:
1. the invention utilizes a laser emission standard, a target to be measured, and a feature detection and recognition component to form a pose measurement system for moving targets (including planar characteristics). By employing multiple laser emission units to cover the motion range of the target and using the feature detection and recognition component to capture laser light spots on the target plane, the system leverages the transformation relationship between the edge features of the target plane and the captured images. Through image processing, the system obtains the coordinate changes of the laser light spots, thereby deriving the motion changes of the target plane and achieving fast, high-precision pose measurement of the moving target. The laser emission system can adopt commercial lasers, which offer stable performance and relatively low cost.
2. The invention is provided with a target board system, which can be a flat plate or a planar target with feature markers. The feature information of the flat plate or target markers is pre-calibrated, making the system cost-effective and stable. The target board system can be determined based on measurement requirements and the six-degree-of-freedom space, offering strong practicality.
3. The invention is suitable for measuring targets of different sizes and ranges. The multiple laser beams emitted by the laser system can cover a large area of the target plane and its motion range. By adjusting the field of view of the detection device and the pose of the lasers, the system can measure the pose of targets of varying sizes and ranges, as long as the field of view fully covers the target plane and its motion range. This makes the measurement solution highly scalable, adaptable, and practical.
4. The measurement principle of the invention is based on laser beam calibration and the principle of equal spatial line segments, making the calculations relatively simple and widely applicable.
5. The system requires at least three laser light spots on the target plane, with the centers of these light spots forming a plane. The limited number of laser light spots facilitates rapid measurement. In some embodiments, the system can emit four laser beams, forming multiple redundant planes, which provide additional data for analysis and optimization, further improving measurement accuracy. The measurement method is straightforward and efficient.
6. All coordinate systems in the invention are based on the laser emission spatial coordinate system, ensuring stable and accurate measurement results.
7. The invention uses the feature detection and recognition component to directly capture images, eliminating the need for strict requirements on the camera's external orientation parameters. This reduces the stability requirements for the camera's position. Only the internal orientation parameters, specifically distortion correction, need to be calibrated. The system can quickly and adaptively calibrate using the edge characteristics of the target plane, making it highly adaptable to different environments.
8. The invention only requires the feature detection and recognition component to capture the complete edge information of the target plane and the relative 2D coordinates of the laser light spots. By coupling this information with the 3D spatial coordinates of the laser beams, the system simplifies calculations, reduces the processing of redundant data, and shortens the measurement cycle, ensuring fast measurement.
9. The feature detection and recognition component and the laser emission standard are independent, but the detection component only needs to cover sufficient feature points and laser spots on the target. Therefore, the placement of the detection component is not fixed and has fewer restrictions. It can be positioned based on the target distance and space, reducing spatial constraints. In some cases, the detection component and the laser emission standard can be placed together, facilitating power supply, centralized control, and maintenance.
10. The laser emission system module is connected to an Invar base plate using Invar support tubes and secured with three push-pull screws. This design allows for easy initial adjustment of the laser direction and ensures high structural rigidity after adjustment. The emission point and laser beam direction remain stable and reliable, with high thermal adaptability, ensuring long-term measurement accuracy.
11. The laser emission system is provided with a reflector, which is rigidly connected to the laser emission end. Once calibrated, the relative position of the reflector remains stable over time, improving the precision of pose measurement.
12. By using multiple laser beams reflected by the reflector to increase the transmission distance, the system achieves double the precision in pose measurement data.
13. The laser light spots reflected back to the target board can be captured simultaneously by the detector along with the laser beams directly emitted from the base. This improves the simplicity and efficiency of the system while ensuring consistency in position and pose measurement timing.
14. By analyzing the changes in the laser light spots reflected back to the target board from multiple laser beams with different directions, the system couples the position and pose changes of the target board. Using the laser beam information from the base emission end, the system obtains high-precision position change information, allowing for the separation of high-precision pose change information.

The target board is made of a high-precision calibrated Invar plate with finely processed edges, ensuring clear and straight edges. The target board itself can serve as a reference ruler, using its edge information to effectively correct optical system distortions. Its high temporal and thermal stability further enhances the accuracy and stability of the measurement system.

The above general description and the following detailed description are exemplary only, and are not intended to limit the scope of the invention.

Other features and aspects of the invention will become clearer from the detailed description of exemplary embodiments with reference to the drawings.

### BRIEF DESCRIPTION OF THE DRAWINGS

In order to explain the embodiments of the invention or the technical solutions in the prior art more clearly, the drawings that need to be used in the description of the embodiments or the prior art will be introduced hereinafter. Obviously, the drawings in the following description are only some embodiments of the invention. For those of ordinary skill in the art, other drawings may be obtained from these drawings without creative efforts.

FIG. 1 is a front view of the high-precision measurement system for the pose of a six-degree-of-freedom parallel mechanism in the embodiment according to the invention;

FIG. 2 is an axonometric diagram of the high-precision measurement system for the pose of a six-degree-of-freedom parallel mechanism in the embodiment according to the invention;

FIG. 3 is an axonometric diagram of the high-precision measurement system for the pose of a six-degree-of-freedom parallel mechanism in the embodiment according to the invention;

FIG. 4 is an axonometric diagram of the high-precision measurement system for the pose of a six-degree-of-freedom parallel mechanism in the embodiment according to the invention;

FIG. 5 is a schematic diagram of the coordinate system for the high-precision measurement system for the pose of a six-degree-of-freedom parallel mechanism in the embodiment according to the invention;

FIG. 6 is a schematic diagram of the coordinate system for the high-precision measurement system for the pose of a six-degree-of-freedom parallel mechanism in the embodiment according to the invention.

In the figures: 1 refers to the laser emission standard; 2 refers to the parallel mechanism fixed platform; 3 refers to the parallel mechanism moving platform; 4 refers to the six-degree-of-freedom parallel mechanism structure; 5 refers to the base; 6 refers to the support frame; 7 refers to the support base plate; 8 refers to the reflector; 9 refers to the laser emission component; 10 refers to the target board; 11 refers to the laser emitter; 12 refers to the laser sleeve; 13 refers to the fixing screw; 14 refers to the adjusting screw; 15 refers to the support holder; 16 refers to the camera detector; 17 refers to the array light spot feature target component; 18 refers to the feature detection and recognition component; 19 refers to the laser module; 20 refers to the feature marking point.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. Based on the embodiments of the invention, all other embodiments obtained by those of ordinary skill in the art without creative work shall all fall within the protection scope of the invention.

In the description of the invention, it should be understood that the orientation or positional relationship indicated by the terms “center”, “upper”, “lower”, “front”, “back, “left”, “right”, “vertical”, “horizontal”, “top”, “bottom”, “inner”, “outer” etc. are based on the orientation or positional relationship shown in the drawings, and is only for the convenience of describing the invention and simplifying the description, but not indicate or imply that the pointed device or element must have a specific orientation, be constructed and operated in a specific orientation, and therefore cannot be understood as a limitation of the invention.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the invention, unless otherwise clearly defined, “plurality” means two or more.

In the invention, unless otherwise clearly defined and limited, the terms “installed”, “connected”, “fixed” and other terms should be interpreted broadly; for example, it can be a fixed connection, a detachable connection or an integral connection; it can be a mechanical connection or an electrical connection; it can be a direct connection or an indirect connection through an intermediary, and it can be a connection between two components. For those of ordinary skill in the art, the specific meanings of the above terms in the invention can be understood according to specific circumstances.

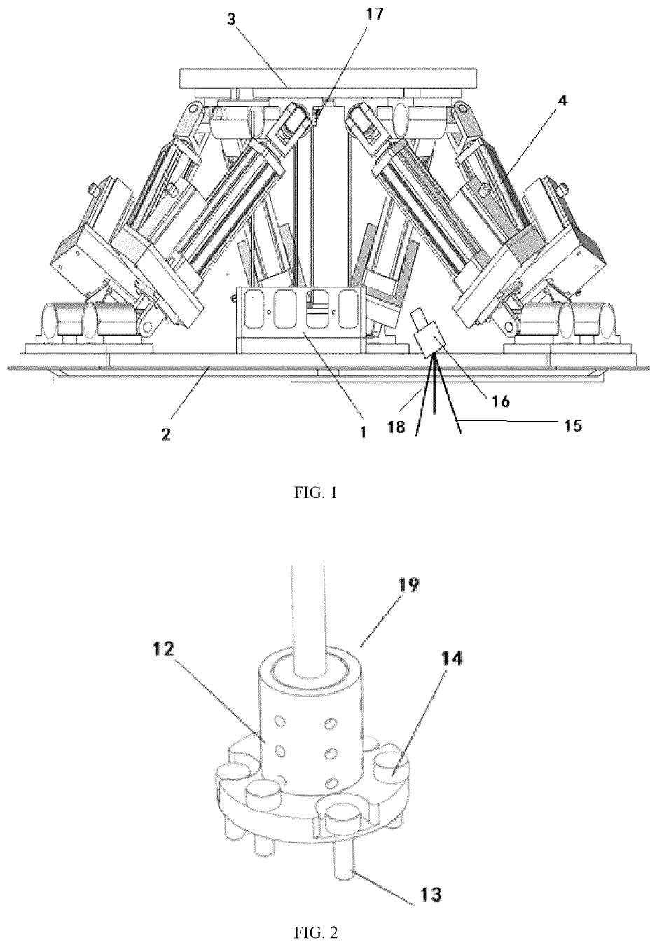

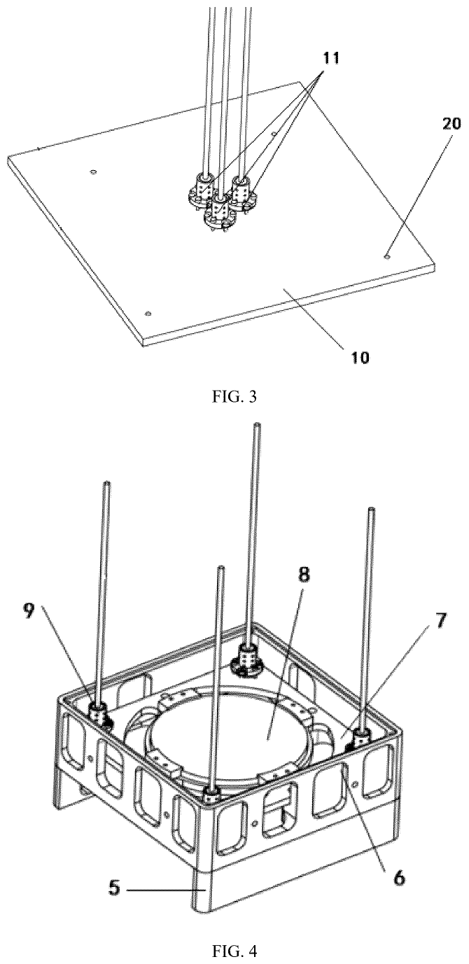

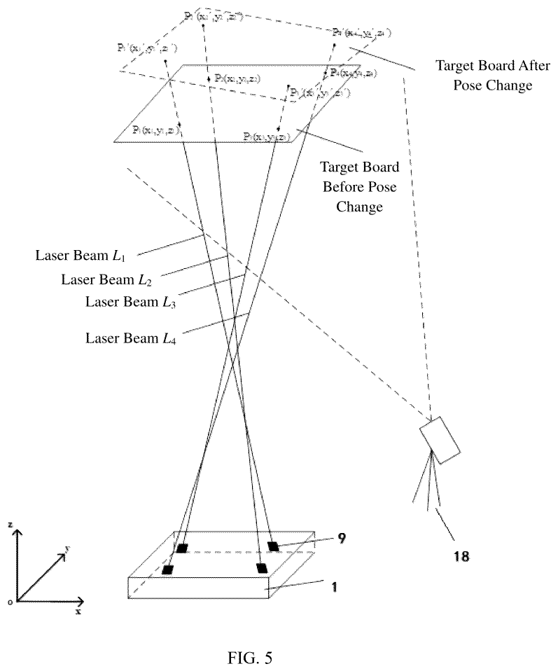

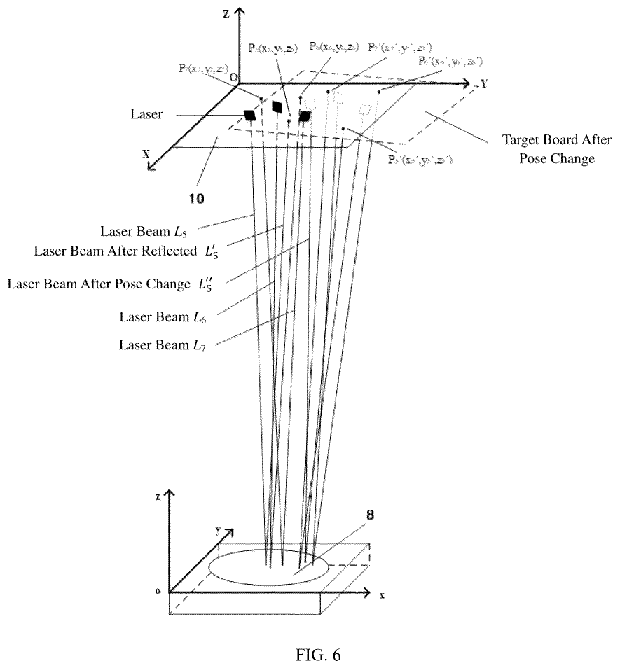

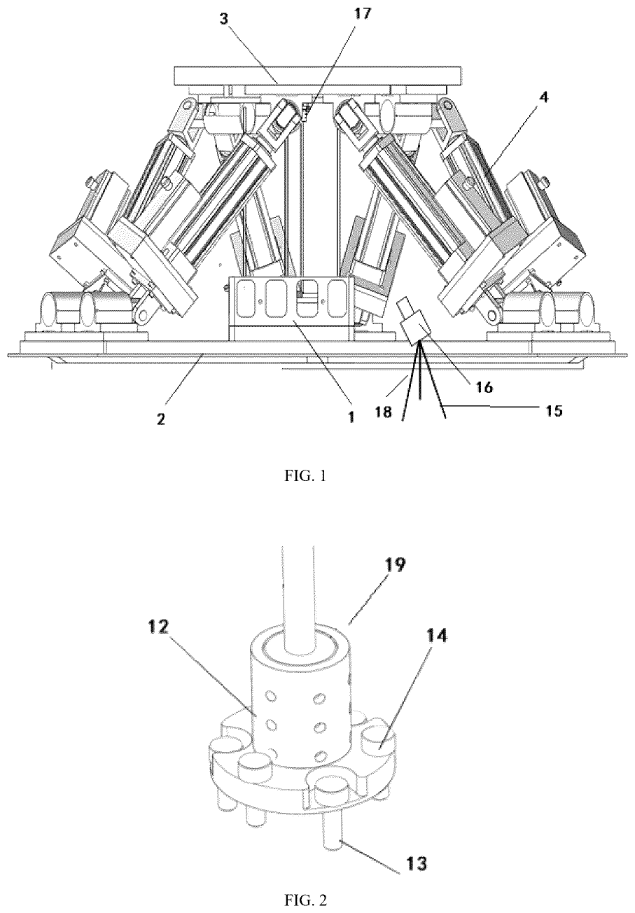

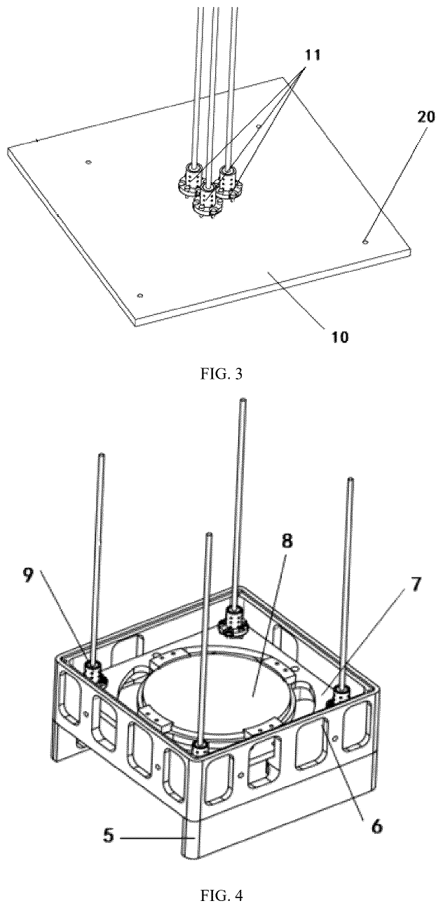

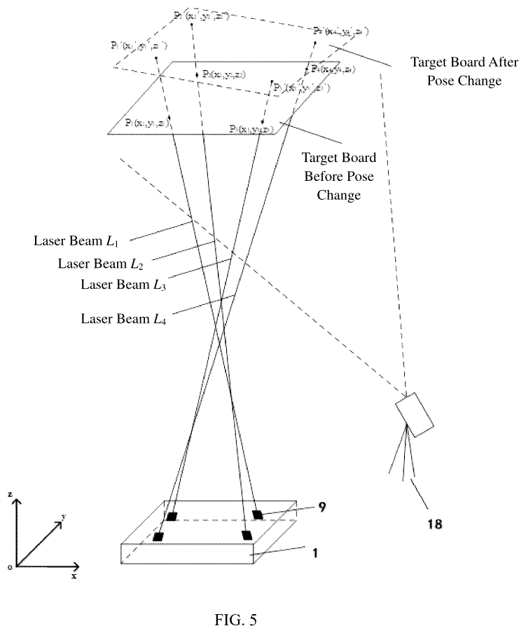

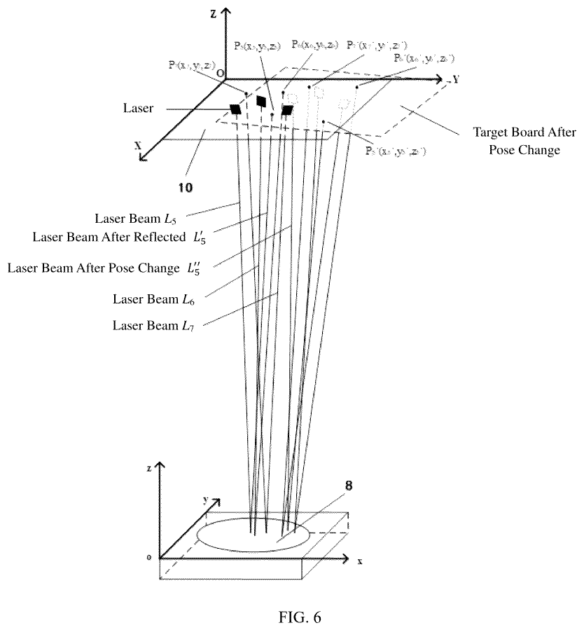

With reference to FIGS. 1-6: Embodiment 1.

A high-precision measurement system for the pose of a six-degree-of-freedom parallel mechanism according to the Embodiment, comprising:
a laser emission standard 1, which is arranged on a top of a parallel mechanism fixed platform 2;
an array light spot feature target component 17, which is arranged above the laser emission standard 1;
a parallel mechanism moving platform 3, wherein the array light spot feature target component 17 is arranged at a bottom of the parallel mechanism moving platform 3, and a top of the array light spot feature target component 17 is fixedly connected to the bottom of the parallel mechanism moving platform 3; the four corners of the bottom of the parallel mechanism moving platform 3 are fixedly connected to the top of the parallel mechanism fixed platform 2 via a six-degree-of-freedom parallel mechanism structure 4; the six-degree-of-freedom parallel mechanism structure 4 achieves the pose change of the parallel mechanism moving platform 3 relative to the parallel mechanism fixed platform 2 through the coordinated expansion and contraction of six rod cylinders; the six-degree-of-freedom parallel mechanism structure 4 is prior art and enables the parallel mechanism moving platform 3 to undergo arbitrary pose changes;
a feature detection and recognition component 18, which is arranged at a bottom of the array light spot feature target component 17, and a detection end of the feature detection and recognition component 18 is oriented toward the array light spot feature target component 17; the feature detection and recognition component 18 is used to recognize the light spot information and target feature information on the array light spot feature target component 17.

In some embodiments, the laser emission standard 1 comprises:
two symmetrically arranged bases 5, and bottoms of the two bases 5 are fixedly connected to the top of the parallel mechanism fixed platform 2;
a support frame 6, which is arranged on a top of the two bases 5, and tops of the two bases 5 are fixedly connected to a bottom of the support frame 6;
a support base plate 7, which is arranged inside the support frame 6, and a side wall of the support base plate 7 is fixedly connected to an inner wall of the support frame 6;
a reflector 8, which is arranged on a top of the support base plate 7, and a mounting end of a bottom of the reflector 8 is fixedly connected to the top of the support base plate 7; the support base plate 7 coincides with an axis of the reflector 8;
a laser emission component 9, which is arranged on the top of the support base plate 7, and a mounting end at a bottom of the laser emission component 9 is fixedly connected to the top of the support base plate 7; the top of the support base plate 7 is provided with at least one laser emission component 9, and the laser emission standard 1 can emit N non-parallel laser beams via the laser emission component 9, wherein N≥3; the laser emission component 9 is a laser module 19 that emits at least three laser beams individually or a beam splitter laser that can emit at least three laser beams.

The support base plate 7 is made of Invar material with a low thermal expansion coefficient and is designed as a flat plate structure. It is equipped with mounting holes compatible with the laser emission component 9, slots for installing the reflector 8, and interfaces for connecting to the support frame 6. The base 5 is provided with mounting interfaces for connecting to the parallel mechanism fixed platform 2.

In some embodiments, the array light spot feature target component 17 comprises:
a target board 10, the top of which is fixedly connected to the bottom of the parallel mechanism moving platform 3; a bottom of the target board 10 is provided with M feature marking points, wherein M≥3, and the positions of the feature marking points on the target board are known;
at least one laser emitter 11, and a mounting end of the laser emitter 11 is fixedly connected to the bottom of the target board 10; the laser emitter 11 is a laser module 19 that emits at least three laser beams individually or a beam splitter that can emit at least three laser beams.

The target board 10 is provided with a mounting interface connected to the parallel mechanism moving platform 3.

In some embodiments, the laser module 19 comprises a laser, a laser sleeve 12, fixing screws 13, and adjusting screws 14; the laser module 19 is fixedly connected to the top of the support base plate 7 or the bottom of the target board 10 via a plurality of the fixing screws 13 and the adjusting screws 14; an inside of the laser sleeve 12 is installed with a laser; the position and pointing of the laser are adjusted using a three-push and three-pull method.

The laser beam emitted by the laser emission standard and the array light spot feature target component is calibrated in advance and defined as a spatial straight line by fitting.

In some embodiments, the feature detection and recognition component comprises:
a support holder 15;
a camera detector 16, which is arranged on a top of the support holder 15, and the top of the support holder 15 is detachably connected to the camera detector 16; a shooting end of the camera detector 16 is provided with an optical lens, and the field of view of the optical lens can cover the target board 10 feature information of the array light spot feature target component 17, as well as the light spot where the laser emitted by the laser emission standard 1 with the target board 10, and the light spot where the laser emitted by the array light spot feature target component 17 itself intersects with the target board 10 through the light beam reflected by the reflector 8.

The support holder 15 is configured to work in conjunction with the camera detector 16. The support holder 15 and the camera detector 16 can be positioned at any location to ensure that the detection end of the camera detector 16 aligns with the array light spot feature target component 17.

In some embodiments, the laser emission standard 1 projects at least three laser beams that irradiate a planar area at the bottom of the target board 10 in different poses and at least three complete laser spots are formed, and the centroids of the three intersecting laser spots are not collinear.

### Embodiment 2

A high-precision measurement method for the pose of a six-degree-of-freedom parallel mechanism according to the embodiment, including the following steps:
step 1: first calibrating and fitting the three-dimensional coordinate equation of the laser beam space; at least three groups of laser emission units emit three laser beams through the laser; the equivalent linear equation of the emitted laser beam is as follows:

$$L 1 \text{:} xj 1 = Xj 10 + tj 1 * Xj 1 ;$$

$$yj 1 = Yj 10 + tj 1 * Yj 1 ;$$

$$zj 1 = Zj 10 + tj 1 * Zj 1 ;$$

$$L 2 \text{:} xj 2 = Xj 20 + tj 2 * Xj 2 ;$$

$$yj 2 = Yj 20 + tj 2 * Yj 2 ;$$

$$zj 2 = Zj 20 + tj 2 * Zj 2 ;$$

$$L 3 \text{:} xj 3 = Xj 30 + tj 3 * Xj 3 ;$$

$$yj 3 = Yj 30 + tj 3 * Yj 3 ;$$

$$zj 3 = Zj 30 + tj 3 * Zj 3 ;$$

in the above formulas: L1, L2, L3 are the equivalent spatial straight line equations of the three laser beams emitted by the three lasers;
(xj1, yj1, zj1) is the coordinate of any point on the laser beam spatial straight line L1 in space;
(xj2, yj2, zj2) is the coordinate of any point on the laser beam spatial straight line L2 in space;
(xj3, yj3, zj3) is the coordinate of any point on the laser beam spatial straight line L3 in space;
Xj10, Yj10, Zj10, Xj1, Yj1, Zj1, Xj20, Yj20, Zj20, Xj2, Yj2, Zj2, Xj30, Yj30, Zj30, Xj3, Yj3, and Zj3 are the constants of the straight line equation; tj1, tj2, and tj3 are the variable parameters of the straight line equation;
step 2: pre-recognizing or calibrating the feature edge or feature point of a specific plane area of the target to be measured, and obtaining the relative position relationship of the feature edge or feature point; the feature point is any position of the plane area to be measured; the feature point is any position in the plane area to be measured; it can be on the edge or inside the plane; the feature point needs to be clear, accurate, easy to identify and stable;
step 3: using the relative position relationship of the plane corner points or edge features calibrated in step 2, the feature detection and recognition component directly photographs the target plane to be measured, and calibrating the camera intrinsic parameters and the camera optical system distortion parameters by using the known corner point and edge feature position relationship and the two-dimensional image captured by the camera;
steps to solve detector distortion based on the double straight line principle:
1) defining the camera lens distortion as:

$$\{ \begin{matrix}{x}_{u} - {C}_{x} = ( {x}_{d} - {C}_{x} ) ( 1 + {λ}_{1} {r}_{d}^{2} + {λ}_{2} {r}_{d}^{4} + ⋯ ) \\ {y}_{u} - {C}_{y} = ( {y}_{d} - {C}_{y} ) ( 1 + {λ}_{1} {r}_{d}^{2} + {λ}_{2} {r}_{d}^{4} + ⋯ )\end{matrix}$$

in the formula, (xᵤ, yᵤ) is the undistorted image point; (x_{d}, y_{d}) is the corresponding distorted image point; λ₁ and λ₂ are the distortion coefficients; (C_{X}, C_{y}) is the distortion center;
2) defining the ideal straight line equation of any straight line on the object to be measured in the image as:

$${ax}_{u} + {by}_{u} + c = 0$$

in the formula, a, b, and c are the parameters of the straight line equation;
3) combining steps 1-2 to get:

$${x}_{d}^{2} + {y}_{d}^{2} + {x}_{d} e + {y}_{d} f + g = 0$$

in the formula,

$$\{ \begin{matrix}e = \frac{a}{c λ} - 2 {C}_{x} \\ f = \frac{b}{c λ} - 2 {C}_{y} \\ g = {C}_{x}^{2} + {C}_{y}^{2} - \frac{a}{c λ} {C}_{x} - \frac{b}{c λ} {C}_{y} + \frac{1}{λ}\end{matrix}$$

4) using the feature detection and recognition component to extract the edge curve (distorted line) corresponding to the ideal straight line on the target image; for any edge curve, (x_{d,i}, y_{d,i}), i=1, 2, . . . , n is any point on the edge; satisfying the formula in step 3 to get:

$${\underbrace{[ \begin{matrix}{x}_{d , 1} & {y}_{d , 1} & 1 \\ {x}_{d , 2} & {y}_{d , 2} & 1 \\ ⋮ & ⋮ & ⋮ \\ {x}_{d , n} & {y}_{d , n} & 1\end{matrix} ]}}_{M} {\underbrace{[ \begin{matrix}e \\ f \\ g\end{matrix} ]}}_{X} = {\underbrace{[ \begin{matrix}- {x}_{d , 1}^{2} - {y}_{d , 1}^{2} \\ - {x}_{d , 2}^{2} - {y}_{d , 2}^{2} \\ ⋮ \\ - {x}_{d , n}^{2} - {y}_{d , n}^{2}\end{matrix} ]}}_{N} ⇒ MX = N$$

5) using the least square method to solve the distortion coefficients e, f and g in step 4, and using the obtained distortion coefficients to correct the image distortion;
step 4: defining a two-dimensional coordinate system by using the plane image of the target board obtained by the feature detection and recognition component, selecting the intersection formed by the two edges of the specific plane as the two-dimensional coordinate origin, and defining the straight line formed by one edge as the X-axis; drawing a perpendicular line to the defined X-axis as the Y-axis of the two-dimensional coordinate system, determining another edge point as the next straight line of the two-dimensional coordinate system, and using this two-dimensional coordinate system to define the two-dimensional position information of the remaining feature points respectively; the subsequent measurement quasi-coordinate system definition remains unchanged; if a two-dimensional coordinate system is defined for a plane feature point, selecting two feature points, one point is defined as the two-dimensional coordinate origin, and the connecting line is used as the X-axis; drawing a perpendicular line to the defined X-axis as the Y-axis of the two-dimensional coordinate system, and determining the coordinates of the third feature point of the three feature points in the two-dimensional coordinate system, including two aspects, one is to use the edge and two feature points to determine the X-axis, but two straight lines and three points are needed to determine a surface, so to define the Y-axis, another edge and feature point must be determined at the same time;
step 5: under the two-dimensional coordinate system established in step 4, using image processing technology, according to the image obtained by the feature detection and recognition component, determining the location of the centroid of the light spot formed by the intersection of the three laser beams emitted by the laser on the plane area of the target to be measured; the two-dimensional coordinates based on the target board system coordinate system are recorded as:

$$P 01 \text{:} ( x 01 , y 01 ) , P 02 \text{:} ( x 02 , y 02 ) , P 03 \text{:} ( x 03 , y 03 ) ;$$

step 6: using the equivalent space straight line equation established in step 1 and the position coordinates obtained in step 5, and the principle that the lengths of the same space line segments are equal in coordinate systems with different proportional factors, calculating the spatial coordinates of the centroid of the light spots where the laser beams emitted by the three lasers intersect the plane area of the target to be measured; the spatial coordinates are defined as the spatial coordinates of the centroid of the three light spots of the target to be measured, which are recorded as: Pq01: (xq01, yq01, zq01), Pq02: (xq02, yq02, zq02), Pq03: (xq03, yq03, zq03);
the specific calculation process is as follows:
according to the principle that the length of space line segments is equal:

$$( xq 01 - xq 02 ) \hat{} 2 + ( yq 01 - yq 02 ) \hat{} 2 + ( zq 01 - zq 02 ) \hat{} 2 = ( x 02 - x 01 ) \hat{} 2 + ( y 02 - y 01 ) \hat{} 2 ;$$

$$( xq 03 - xq 02 ) \hat{} 2 + ( yq 03 - yq 02 ) \hat{} 2 + ( zq 03 - zq 02 ) \hat{} 2 = ( x 02 - x 03 ) \hat{} 2 + ( y 02 - y 03 ) \hat{} 2 ;$$

$$( xq 03 - xq 01 ) \hat{} 2 + ( yq 03 - yq 01 ) \hat{} 2 + ( zq 03 - zq 01 ) \hat{} 2 = ( x 01 - x 03 ) \hat{} 2 + ( y 01 - y 03 ) \hat{} 2 ;$$

combined with the three laser fitting space straight line equations, the spatial coordinates of any three points in the plane area of the target to be measured based on the laser emission reference coordinate system can be calculated, Pq01: (xq01, yq01, zq01), Pq02: (xq02, yq02, zq02), Pq03: (xq03, yq03, zq03);
step 8: the coordinates of the three light spots in the target board coordinate system are P01: (x01, y01, 0), P02: (x02, y02, 0), and P03: (x03, y03, 0); by using the BURSA principle (a method for coordinate transformation), the coordinates of the common points in the two coordinate systems can be solved to obtain the position translation and attitude deviation in the two coordinate systems;

$$[ \begin{matrix}{X}_{Ti} - {X}_{i} \\ {Y}_{Ti} - {T}_{i} \\ {Z}_{Ti} - {Z}_{i}\end{matrix} ] = [ \begin{matrix}1 & 0 & 0 & {X}_{i} & 0 & - {Z}_{i} & {Y}_{i} \\ 0 & 1 & 0 & {Y}_{i} & {Z}_{i} & 0 & - {X}_{i} \\ 0 & 0 & 1 & {Z}_{i} & - {Y}_{i} & {X}_{i} & 0\end{matrix} ] * [ \begin{matrix}Δ X \\ Δ Y \\ Δ Z \\ k \\ {ε}_{X} \\ {ε}_{Y} \\ {ε}_{Z}\end{matrix} ]$$

(XTi, YTi, ZTi) are the three-dimensional coordinates of the three light spots in the laser emission reference coordinate system, (Xi, Yi, Zi) are the three-dimensional coordinates based on the target board system coordinate system (Zi=0 is defined); (ΔX, ΔY, ΔZ) are the position translations of the emission and target coordinate systems, k is the calculation scale factor of the two coordinate systems, and (εX, εY, εZ) are the attitude deviation angles of the emission and target coordinate systems;
step 9: repeating steps 3-8, and using the position translation and attitude deviation angle of the target board coordinate system relative to the emission reference coordinate system solved under different attitudes to obtain the target's three-degree-of-freedom position information and three-degree-of-freedom attitude information;
step 10: defining an edge of the target board as the X-axis of the target board system coordinate system, defining the corner point of this edge and the adjacent edge as the origin, taking the plane of the target board as the XOY plane, and the direction perpendicular to the plane of the target board as the Z-axis to establish the target board system coordinate system;
step 11: defining the laser beams emitted by the three lasers on the target board system as L₅, L₆ and L₇, respectively;
step 12: taking the laser beam L₅ as an example, the rotation matrix R and translation matrix T between the target board system coordinate system and the laser emission system coordinate system are obtained by the three-dimensional structured light method to solve the spatial straight line equation of laser beam L₅ in the laser emission system coordinate system:
the conversion relationship between the target board coordinate system and the laser emission system coordinate system is as follows:

$$[ \begin{matrix}{X}_{2} \\ {Y}_{2} \\ {Z}_{2}\end{matrix} ] = R * [ \begin{matrix}{X}_{1} \\ {Y}_{1} \\ {Z}_{1}\end{matrix} ] + [ \begin{matrix}{t}_{1} \\ {t}_{2} \\ {t}_{3}\end{matrix} ]$$

wherein

$$[ \begin{matrix}{X}_{1} \\ {Y}_{1} \\ {Z}_{1}\end{matrix} ]$$

represents the coordinates in the target board coordinate system, and

$$[ \begin{matrix}{X}_{2} \\ {Y}_{2} \\ {Z}_{2}\end{matrix} ]$$

represents the coordinates in the laser emission system coordinate system;
R is a 3×3 rotation matrix, which describes the rotation relationship between the target board coordinate system and the laser emission system coordinate system:

$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

T is the translation vector, which describes the translation relationship from the target board coordinate system to the laser emission system coordinate system:

$$T = [ \begin{matrix}{t}_{1} \\ {t}_{2} \\ {t}_{3}\end{matrix} ]$$

defining the spatial straight line equation L₅ of the laser beam in the target board coordinate system as follows:

$${X}_{1} = {a}_{1} {s}_{1} + {b}_{1}$$

$${Y}_{1} = {c}_{1} {s}_{1} + {d}_{1}$$

$${Z}_{1} = {s}_{1}$$

converting L₅ in the target board coordinate system to the laser emission system coordinate system as follows:

$$[ \begin{matrix}{X}_{2} \\ {Y}_{2} \\ {Z}_{2}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{a}_{1} {S}_{1} + {b}_{1} \\ {c}_{1} {S}_{1} + {d}_{1} \\ {S}_{1}\end{matrix} ] + [ \begin{matrix}{t}_{1} \\ {t}_{2} \\ {t}_{3}\end{matrix} ]$$

the three coordinate components are:

$${X}_{2} = ( {r}_{11} {a}_{1} + {r}_{12} {c}_{1} + {r}_{13} ) {S}_{1} + ( {r}_{11} {b}_{1} + {r}_{12} {d}_{1} + {t}_{1} )$$

$${Y}_{2} = ( {r}_{21} {a}_{1} + {r}_{22} {c}_{1} + {r}_{23} ) {S}_{1} + ( {r}_{21} {b}_{1} + {r}_{22} {d}_{1} + {t}_{2} )$$

$${Z}_{2} = ( {r}_{31} {a}_{1} + {r}_{32} {c}_{1} + {r}_{33} ) {S}_{1} + ( {r}_{31} {b}_{1} + {r}_{32} {d}_{1} + {t}_{3} )$$

solving the equation of the laser beam L₅ in the laser emission system coordinate system as follows:

$${X}_{2} = {A}_{2} {S}_{1} + {B}_{2}$$

$${Y}_{2} = {C}_{2} {S}_{1} + {D}_{2}$$

$${Z}_{2} = {E}_{2} {S}_{1} + {F}_{2}$$

wherein,

$${A}_{2} = {r}_{11} {a}_{1} + {r}_{12} {c}_{1} + {r}_{13} , {B}_{2} = {r}_{11} {b}_{1} + {r}_{12} {d}_{1} + {t}_{1}$$

$${C}_{2} = {r}_{21} {a}_{1} + {r}_{22} {c}_{1} + {r}_{23} , {D}_{2} = {r}_{21} {b}_{1} + {r}_{22} {d}_{1} + {t}_{2}$$

$${E}_{2} = {r}_{31} {a}_{1} + {r}_{32} {c}_{1} + {r}_{33} , {F}_{2} = {r}_{31} {b}_{1} + {r}_{32} {d}_{1} + {t}_{3}$$

step 13: defining the reflector plane as the plane with Z=0 in the laser emission system coordinate system, then the equation of the spatial straight line after the laser beam L₅ is reflected by the reflector is L₅′:

$${X}_{2}^{′} = {X}_{2} = {A}_{2} {S}_{1} + {B}_{2}$$

$${Y}_{2}^{′} = {Y}_{2} = {C}_{2} {S}_{1} + {D}_{2}$$

$${Z}_{2}^{′} = - {Z}_{2} = - ( {E}_{2} {S}_{1} + {F}_{2} )$$

step 14: using the stereo structured light method to solve the equation of the target board plane in the laser emission system coordinate system; the target board plane M₁ is:

$${M}_{1} : {A}_{3} x + {B}_{3} y + {C}_{3} z + {D}_{3} = 0$$

step 15: solving the intersection coordinates P₅(X₅, Y₅, Z₅) of the laser beam L₅′ after being reflected by the reflector and the target board plane M₁;
   wherein the intersection point P₅(X₅, Y₅, Z₅) satisfies the spatial straight line equation of the laser beam L₅′,

$${x}_{5} = {X}_{2}^{′} = {A}_{2} {S}_{1} + {B}_{2}$$

$${y}_{5} = {Y}_{2}^{′} = {C}_{2} {S}_{1} + {D}_{2}$$

$${z}_{5} = {Z}_{2}^{′} = - ( {E}_{2} {S}_{1} + {F}_{2} )$$

substituting X₅, Y₅, Z₅ into the target plane equation A₃x+B₃y+C₃z+D₃=0:

$${A}_{3} ( {A}_{2} {S}_{1} + {B}_{2} ) + {B}_{3} ( {C}_{2} {S}_{1} + {D}_{2} ) + {C}_{3} ( - ( {E}_{2} {S}_{1} + {F}_{2} ) ) + {D}_{3} = 0$$

after expansion:

$$( {A}_{3} {A}_{2} + {B}_{3} {C}_{2} - {C}_{3} {E}_{2} ) {S}_{1} + ( {A}_{3} {B}_{2} + {B}_{3} {D}_{2} - {C}_{3} {F}_{2} + {D}_{3} ) = 0$$

after solving the parameter S₁, substituting it into the intersection coordinate formula to get the intersection coordinates:

$${x}_{5} = - \frac{{A}_{2} {k}_{2}}{{k}_{1}} + {B}_{2}$$

$${y}_{5} = - \frac{{C}_{2} {k}_{2}}{{k}_{1}} + {D}_{2}$$

$${z}_{5} = \frac{{E}_{2} {k}_{2}}{{k}_{1}} - {F}_{2}$$

wherein:

$${k}_{1} = {A}_{3} {A}_{2} + {B}_{3} {C}_{2} - {C}_{3} {E}_{2}$$

$${k}_{2} = {A}_{3} {B}_{2} + {B}_{3} {D}_{2} - {C}_{3} {E}_{2} + {D}_{3}$$

step 16: using the stereo structured light method to solve the pose change of the target board under the laser emission system as Δx, Δy, Δz, α, β, γ;
step 17: according to the pose change in step 16, Δx, Δy, Δz, α, β, γ, the rotation matrix R′ and translation matrix T′ representing the pose change of the target board system in the laser emission system coordinate system are:

$${R}^{′} = [ \begin{matrix}cos β cos γ & cos γ sin α sin β - cos α sin γ & sin α sin γ + cos α cos γ sin β \\ cos β sin γ & cos α cos γ + sin α sin β sin γ & cos α sin β sin γ - cos γ sin α \\ - sin β & cos β sin α & cos α cos β\end{matrix} ]$$

$${T}^{′} = [ \begin{matrix}Δ x \\ Δ y \\ Δ z\end{matrix} ]$$

step 18: according to the rotation matrix R′ and translation matrix T′ obtained in step 17, calculating the spatial straight line equation L″₅ of the laser beam L₅ after the pose change: substituting the linear equation (X₂, Y₂, Z₂) of the laser beam L₅ into the rotation and translation formulas:

$$[ \begin{matrix}{X}_{3} \\ {Y}_{3} \\ {Z}_{3}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \cdot [ \begin{matrix}{A}_{2} {S}_{1} + {B}_{2} \\ {C}_{2} {S}_{1} + {D}_{2} \\ {E}_{2} {S}_{1} + {F}_{2}\end{matrix} ] + [ \begin{matrix}Δ x \\ Δ y \\ Δ z\end{matrix} ]$$

the linear equation of the laser beam space after the pose change is:

$${X}_{3} = {A}_{3} {S}_{1} + {B}_{3}$$

$${Y}_{3} = {C}_{3} {S}_{1} + {D}_{3}$$

$${Z}_{3} = {E}_{3} {S}_{1} + {F}_{3}$$

wherein:

$${A}_{3} = {r}_{11} {A}_{2} + {r}_{12} {C}_{2} + {r}_{13} {E}_{2} , {B}_{3} = {r}_{11} {B}_{2} + {r}_{12} {D}_{2} + {r}_{13} {F}_{2} + Δ x$$

$${C}_{3} = {r}_{21} {A}_{2} + {r}_{22} {C}_{2} + {r}_{23} {E}_{2} , {D}_{3} = {r}_{21} {B}_{2} + {r}_{22} {D}_{2} + {r}_{23} {F}_{2} + Δ y$$

$${E}_{3} = {r}_{31} {A}_{2} + {r}_{32} {C}_{2} + {r}_{33} {E}_{2} , {F}_{3} = {r}_{31} {B}_{2} + {r}_{32} {D}_{2} + {r}_{33} {F}_{2} + Δ z$$

step 19: the spatial straight line equation of the laser beam L″₅ after being reflected by the reflector becomes L′″₅:

$${X}_{3} = {A}_{3} {S}_{1} + {B}_{3}$$

$${Y}_{3} = {C}_{3} {S}_{1} + {D}_{3}$$

$${Z}_{3} = - {E}_{3} {S}_{1} - {F}_{3}$$

step 20: after the pose change of the target board plane, the plane equation of the target board plane M₁ in the laser emission system coordinate system becomes:

$${M}_{1}^{′} : {A}_{3}^{′} + {B}_{3}^{′} y + {C}_{3}^{′} z + {D}_{3}^{′} = 0$$

wherein:

$$[ \begin{matrix}{A}_{3}^{′} \\ {B}_{3}^{′} \\ {C}_{3}^{′}\end{matrix} ] = {R}^{T} \cdot [ \begin{matrix}{A}_{3} \\ {B}_{3} \\ {C}_{3}\end{matrix} ] , {D}_{3}^{′} = {D}_{3} - ( {A}_{3}^{′} Δ x + {B}_{3}^{′} Δ y + {C}_{3}^{′} Δ z )$$

step 21: solving the intersection coordinates

$${P}_{5}^{′} ( {x}_{5}^{′} , {y}_{5}^{′} , {z}_{5}^{′} )$$

of the laser beam L′″₅ and the plane M′₁ as follows:

$${x}_{5}^{′} = - \frac{{A}_{3} {K}_{2}^{′}}{{K}_{1}^{′}} + {B}_{3}$$

$${y}_{5}^{′} = - \frac{{C}_{3} {K}_{2}^{′}}{{K}_{1}^{′}} + {D}_{3}$$

$${z}_{5}^{′} = - \frac{{A}_{3} {K}_{2}^{′}}{{K}_{1}^{′}} - {F}_{3}$$

wherein:

$${k}_{1}^{′} = {A}_{3}^{′} {A}_{3} + {B}_{3}^{′} {C}_{3} - {C}_{3}^{′} {E}_{2}$$

$${k}_{2}^{′} = {A}_{3}^{′} {B}_{3} + {B}_{3}^{′} {D}_{3} - {C}_{3}^{′} {F}_{3} + {D}_{3}^{′}$$

step 22: according to the camera detector, the distance between the laser beam and the light spot on the target board plane after the pose change is ΔL₁;
step 23: combining steps 16 and 21 to solve the intersection coordinates P₅(X₅, Y₅, Z₅) and

$${P}_{5}^{′} ( {x}_{5}^{′} , {y}_{5}^{′} , {z}_{5}^{′} )$$

before and after the pose change and the distance ΔL₁ in step 23 to get:

$$Δ {L}_{1} = {\{ {[ ( - \frac{{A}_{2} {k}_{2}}{{k}_{1}} + {B}_{2} ) - ( - \frac{{A}_{3} {k}_{2}^{′}}{{k}_{1}^{′}} + {B}_{2} ) ]}^{2} + {[ ( C - \frac{{C}_{2} {k}_{2}}{{k}_{1}} + {D}_{2} ) - ( - \frac{{C}_{3} {k}_{2}^{′}}{{k}_{1}^{′}} + {D}_{3} ) ]}^{2} + {[ ( \frac{{E}_{2} {k}_{3}}{{k}_{1}} - {F}_{2} ) - ( \frac{{E}_{3} {k}_{1}^{′}}{{k}_{1}^{′}} + {F}_{3} ) ]}^{2} \}}^{\frac{1}{2}}$$

$${\{ {[ ( - \frac{{A}_{2} {k}_{2}}{{k}_{1}} + {B}_{2} ) - ( - \frac{{A}_{3} {k}_{2}^{′}}{{k}_{1}^{′}} + {B}_{2} ) ]}^{2} + {[ ( C - \frac{{C}_{2} {k}_{2}}{{k}_{1}} + {D}_{2} ) - ( - \frac{{C}_{3} {k}_{2}^{′}}{{k}_{1}^{′}} + {D}_{3} ) ]}^{2} + {[ ( \frac{{E}_{2} {k}_{3}}{{k}_{1}} - {F}_{2} ) - ( \frac{{E}_{3} {k}_{1}^{′}}{{k}_{1}^{′}} - {F}_{3} ) ]}^{2} \}}^{\frac{1}{2}} - Δ {L}_{1} = 0$$

the above relationship can be written as a form containing three unknowns α, β, and γ:

$${F}_{1} ( α , β , γ ) = 0$$

step 24: repeating steps 12-23 to obtain the equations of laser beams L₆, L₇ and ΔL₂, ΔL₃ with respect to α, β, γ:

$${F}_{2} ( α , β , γ ) = 0$$

$${F}_{3} ( α , β , γ ) = 0$$

step 25: transforming the equations in steps 23-24 into:

$$F ( α , β , γ ) = {F}_{1} + {F}_{2} + {F}_{3} = 0$$

step 26: using the Gauss-Newton nonlinear least squares algorithm to solve the angles α, β, γ; finally, obtaining the pose information of the array light spot feature target component relative to the laser emission standard;
step 27: repeating steps 3-26, and using the position translation and attitude deviation angle of the target board coordinate system relative to the emission reference coordinate system solved under different poses to obtain the three-degree-of-freedom position information and three-degree-of-freedom attitude information of the target, and feeding back the six-degree-of-freedom array light spot feature target component pose information, i.e. the parallel mechanism moving platform pose information, to the six-degree-of-freedom parallel mechanism structure in real time for motion adjustment;
step 28: measuring the pose information and converting it into the pose adjustment information of the six-degree-of-freedom parallel mechanism structure:
the parallel mechanism base coordinate system {B} is located on the parallel mechanism fixed platform; the parallel mechanism base coordinate system {B} is the reference datum of other coordinate systems; the moving platform coordinate system {P} is located on the parallel mechanism moving platform; {M} is the laser emission reference coordinate system of the measurement system; {T} is the target board coordinate system; the relative position of the target board coordinate system and the moving platform coordinate system is fixed;
the transformation relationship between coordinate systems is expressed by the homogeneous transformation matrix; the pose transformation relationship from the moving platform coordinate system {P} to the base coordinate system {B} is represented by

$${T}_{P}^{B} \text{?} ;$$

$$\text{?} \text{indicates text missing or illegible when filed}$$

similarly, the pose transformation from the target board coordinate system {T} to the base coordinate system {B} is represented by

$${T}_{T}^{B} \text{?} ,$$

$$\text{?} \text{indicates text missing or illegible when filed}$$

and the pose transformation from the target board coordinate system {T} to the moving platform coordinate system {P} is represented by

$${T}_{T}^{P} \text{?} ;$$

$$\text{?} \text{indicates text missing or illegible when filed}$$

the pose transformation matrix is:

$$\text{?} = [ \begin{matrix}\text{?} & \text{?} \\ 0 & 1\end{matrix} ] , \text{?} = [ \begin{matrix}\text{?} & \text{?} \\ 0 & 1\end{matrix} ] , \text{?} = [ \begin{matrix}\text{?} & \text{?} \\ 0 & 1\end{matrix} ] \qquad ( 1 )$$

$$\text{?} \text{indicates text missing or illegible when filed}$$

the above coordinate system transformation relationship satisfies:

$${T}_{T}^{B} = {T}_{P}^{B} {T}_{T}^{P} \qquad ( 2 )$$

combined with the pose transformation matrix, it can be expressed as:

$$[ \begin{matrix}\text{?} & \text{?} \\ 0 & 1\end{matrix} ] = [ \begin{matrix}\text{?} & \text{?} \\ 0 & 1\end{matrix} ] [ \begin{matrix}\text{?} & \text{?} \\ 0 & 1\end{matrix} ] \qquad ( 4 )$$

$$\text{?} \text{indicates text missing or illegible when filed}$$

it can be obtained from formula 2 that:

$${R}_{T}^{B} = {R}_{P}^{B} {R}_{T}^{P} \qquad ( 5 )$$

$${P}_{T}^{B} = {R}_{P}^{B} {P}_{T}^{P} + {P}_{P}^{B} \qquad ( 6 )$$

similarly, in the laser emission reference coordinate system, (5) and (6) can be expressed as

$${R}_{T}^{B} = {R}_{M}^{B} {R}_{T}^{M} \qquad ( 7 )$$

$${P}_{T}^{B} = {R}_{M}^{B} {P}_{T}^{M} + {P}_{M}^{B} \qquad ( 8 )$$

combining formulas (5)-(8) to obtain the rotation matrix and translation matrix of the six-degree-of-freedom parallel mechanism structure:

$$\text{?} = \text{?} \qquad ( 9 )$$

$${P}_{P}^{B} = {R}_{M}^{B} {P}_{T}^{M} + {P}_{M}^{B} - {R}_{P}^{B} {P}_{T}^{P} \qquad ( 10 )$$

$$\text{?} \text{indicates text missing or illegible when filed}$$

the measured pose information can be converted into the pose information of the six-degree-of-freedom parallel mechanism structure through formulas (9) and (10), where

$${R}_{T}^{M} and {P}_{T}^{M}$$

are the rotation matrix and translation matrix calculated from the three-degree-of-freedom pose information and the three-degree-of-freedom pose information obtained in step 27,

$${R}_{M}^{B} , {R}_{T}^{P} , {P}_{M}^{B} , and {P}_{T}^{P}$$

are fixed values that can be obtained based on the measurement results of multiple pose points.

The implementation principle of the invention is:

The measurement system is mainly composed of a laser emission standard, an array light spot feature target component, and a feature detection and recognition component. The measurement system uses a laser emission standard installed on a fixed platform to emit more than three light beams (the spatial straight lines have been calibrated) to illuminate the array light spot feature target component fixed on the moving platform, which contains clear (calibrated in advance) plane edges and target feature point information. The feature detection and recognition component that can cover the entire motion range of the array light spot feature target component is used to recognize the light spot information on the target system plane. The acquired information contains complete target plane edge information and the relative two-dimensional position information of the laser light spot. The two-dimensional coordinates of the centroid of the light spot are quickly defined by image processing, and the three-dimensional spatial straight line information of the laser beam is coupled to directly obtain the three-dimensional spatial coordinates of the light spot where the laser beam intersects the target surface, thereby obtaining the three-degree-of-freedom position information of the target to be measured. At the same time, at least three laser beams emitted from the array light spot feature target component irradiate on the fixed reflector on the laser emission standard and are reflected to the target board on the array light spot feature target component. The feature detection and recognition component also recognizes its two-dimensional change information, and combines the determined measurement distance to solve the three-degree-of-freedom posture information of the target board, and finally completes the fast and ultra-high-precision six-degree-of-freedom posture measurement of the six-degree-of-freedom parallel mechanism structure.

Obviously, those skilled in the art can make various modifications and variations to the invention without departing from the spirit and scope of the invention. Therefore, if such modifications and variations of the invention fall within the scope of the claims of the invention and the equivalents thereof, the invention is also intended to encompass these modifications and variations.

1. A high-precision measurement system for the pose of a six-degree-of-freedom parallel mechanism, comprising:
a laser emission standard, which is arranged on a top of a parallel mechanism fixed platform;
an array light spot feature target component, which is arranged above the laser emission standard;
a parallel mechanism moving platform, wherein the array light spot feature target component is arranged at a bottom of the parallel mechanism moving platform, and a top of the array light spot feature target component is fixedly connected to the bottom of the parallel mechanism moving platform; the four corners of the bottom of the parallel mechanism moving platform are fixedly connected to the top of the parallel mechanism fixed platform via a six-degree-of-freedom parallel mechanism structure;
a feature detection and recognition component, which is arranged at a bottom of the array light spot feature target component, and a detection end of the feature detection and recognition component is oriented toward the array light spot feature target component; the feature detection and recognition component is used to recognize the light spot information and target feature information on the array light spot feature target component.

2. The high-precision measurement system for the pose of a six-degree-of-freedom parallel mechanism of claim 1, wherein the laser emission standard comprises:
two symmetrically arranged bases, and bottoms of the two bases are fixedly connected to the top of the parallel mechanism fixed platform;
a support frame, which is arranged on a top of the two bases, and tops of the two bases are fixedly connected to a bottom of the support frame;
a support base plate, which is arranged inside the support frame, and a side wall of the support base plate is fixedly connected to an inner wall of the support frame;
a reflector, which is arranged on a top of the support base plate, and a mounting end of a bottom of the reflector is fixedly connected to the top of the support base plate; the support base plate coincides with an axis of the reflector;
a laser emission component, which is arranged on the top of the support base plate, and a mounting end at a bottom of the laser emission component is fixedly connected to the top of the support base plate; the top of the support base plate is provided with at least one laser emission component, and the laser emission standard can emit N non-parallel laser beams via the laser emission component, wherein N≥3; the laser emission component is a laser module that emits at least three laser beams individually or a beam splitter laser that can emit at least three laser beams.

3. The high-precision measurement system for the pose of a six-degree-of-freedom parallel mechanism of claim 2, wherein the array light spot feature target component comprises:
a target board, the top of which is fixedly connected to the bottom of the parallel mechanism moving platform; a bottom of the target board is provided with M feature marking points, wherein M≥3, and the positions of the feature marking points on the target board are known;
at least one laser emitter, and a mounting end of the laser emitter is fixedly connected to the bottom of the target board; the laser emitter is a laser module that emits at least three laser beams individually or a beam splitter that can emit at least three laser beams.

4. The high-precision measurement system for the pose of a six-degree-of-freedom parallel mechanism of claim 3, wherein the laser module comprises a laser, a laser sleeve, fixing screws, and adjusting screws; the laser module is fixedly connected to the top of the support base plate or the bottom of the target board via a plurality of the fixing screws and the adjusting screws; an inside of the laser sleeve is installed with a laser;
the laser beam emitted by the laser emission standard and the array light spot feature target component is calibrated in advance and defined as a spatial straight line by fitting.

5. The high-precision measurement system for the pose of a six-degree-of-freedom parallel mechanism of claim 4, wherein the feature detection and recognition component comprises:
a support holder;
a camera detector, which is arranged on a top of the support holder, and the top of the support holder is detachably connected to the camera detector; a shooting end of the camera detector is provided with an optical lens, and the field of view of the optical lens can cover the target board feature information of the array light spot feature target component, as well as the light spot where the laser emitted by the laser emission standard with the target board, and the light spot where the laser emitted by the array light spot feature target component itself intersects with the target board through the light beam reflected by the reflector.

6. The high-precision measurement system for the pose of a six-degree-of-freedom parallel mechanism of claim 5, wherein the laser emission standard projects at least three laser beams that irradiate a planar area at the bottom of the target board in different poses and at least three complete laser spots are formed, and the centroids of the three intersecting laser spots are not collinear.

7. A high-precision measurement method for the pose of a six-degree-of-freedom parallel mechanism of claim 6, wherein the high-precision measurement system for the pose of a six-degree-of-freedom parallel mechanism is used for the high-precision measurement of the pose of a six-degree-of-freedom parallel mechanism, including the following steps:
step 1: first calibrating and fitting the three-dimensional coordinate equation of the laser beam space; at least three groups of laser emission units emit three laser beams through the laser; the equivalent linear equation of the emitted laser beam is as follows:
$$L 1 : xj 1 = Xj 10 + tj 1 * Xj 1 ;$$
$$yj 1 = Yj 10 + tj 1 * Yj 1 ;$$
$$zj 1 = Zj 10 + tj 1 * Zj 1 ;$$
$$L 2 : xj 2 = Xj 20 + tj 2 * Xj 2 ;$$
$$yj 2 = Yj 20 + tj 2 * Yj 2 ;$$
$$zj 2 = Zj 20 + tj 2 * Zj 2 ;$$
$$L 3 : xj 3 = Xj 30 + tj 3 * Xj 3 ;$$
$$yj 3 = Yj 30 + tj 3 * Yj 3 ;$$
$$zj 3 = Zj 30 + tj 3 * Zj 3 ;$$
in the above formulas: L1, L2, L3 are the equivalent spatial straight line equations of the three laser beams emitted by the three lasers;
(xj1, yj1, zj1) is the coordinate of any point on the laser beam spatial straight line L1 in space;
(xj2, yj2, zj2) is the coordinate of any point on the laser beam spatial straight line L2 in space;
(xj3, yj3, zj3) is the coordinate of any point on the laser beam spatial straight line L3 in space;
Xj10, Yj10, Zj10, Xj1, Yj1, Zj1, Xj20, Yj20, Zj20, Xj2, Yj2, Zj2, Xj30, Yj30, Zj30, Xj3, Yj3, and Zj3 are the constants of the straight line equation; tj1, tj2, and tj3 are the variable parameters of the straight line equation;
step 2: pre-recognizing or calibrating the feature edge or feature point of a specific plane area of the target to be measured, and obtaining the relative position relationship of the feature edge or feature point; the feature point is any position of the plane area to be measured;
step 3: using the relative position relationship of the plane corner points or edge features calibrated in step 2, the feature detection and recognition component directly photographs the target plane to be measured, and calibrating the camera intrinsic parameters and the camera optical system distortion parameters by using the known corner point and edge feature position relationship and the two-dimensional image captured by the camera;
steps to solve detector distortion based on the double straight line principle:
1) defining the camera lens distortion as:
$$\{ \begin{matrix}{x}_{u} - {C}_{x} = ( {x}_{d} - {C}_{x} ) ( 1 + {λ}_{1} {r}_{d}^{2} + {λ}_{2} {r}_{d}^{4} + … ) \\ {y}_{u} - {C}_{y} = ( {y}_{d} - {C}_{y} ) ( 1 + {λ}_{1} {r}_{d}^{2} + {λ}_{2} {r}_{d}^{4} + … )\end{matrix} \text{?}$$
in the formula, (xᵤ, yᵤ) is the undistorted image point; (x_{d}, y_{d}) is the corresponding distorted image point; λ₁ and λ₂ are the distortion coefficients; (Cₓ, C_{y}) is the distortion center;
2) defining the ideal straight line equation of any straight line on the object to be measured in the image as:
$${ax}_{u} + {by}_{u} + c = 0$$
in the formula, a, b, and c are the parameters of the straight line equation;
3) combining steps 1-2 to get:
$${x}_{d}^{2} + {y}_{d}^{2} + {x}_{d} e + {y}_{d} f + g = 0$$
in the formula,
$$\{ \begin{matrix}e = \frac{a}{c λ} - 2 {C}_{x} \\ f = \frac{b}{c λ} - 2 {C}_{y} \\ g = {C}_{x}^{2} + {C}_{y}^{2} - \frac{a}{c λ} {C}_{x} - \frac{b}{c λ} {C}_{y} + \frac{1}{λ}\end{matrix}$$
4) using the feature detection and recognition component to extract the edge curve (distorted line) corresponding to the ideal straight line on the target image; for any edge curve, (x_{d,i}, y_{d,i}), i=1, 2, . . . , n is any point on the edge; satisfying the formula in step 3 to get:
$$\underbrace{[ \begin{matrix}{x}_{d , 1} & {y}_{d , 1} & 1 \\ {x}_{d , 2} & {y}_{d , 2} & 1 \\ ⋮ & ⋮ & ⋮ \\ {x}_{d , n} & {y}_{d , n} & 1\end{matrix} ]}_{M} \underbrace{[ \begin{matrix}e \\ f \\ g\end{matrix} ]}_{X} = \underbrace{[ \begin{matrix}- {x}_{d , 1}^{2} - {y}_{d , 1}^{2} \\ - {x}_{d , 2}^{2} - {y}_{d , 2}^{2} \\ ⋮ \\ - {x}_{d , n}^{2} - {y}_{d , n}^{2}\end{matrix} ]}_{N} ⇒ MX = N$$
5) using the least square method to solve the distortion coefficients e, f and g in step 4, and using the obtained distortion coefficients to correct the image distortion;
step 4: defining a two-dimensional coordinate system by using the plane image of the target board obtained by the feature detection and recognition component, selecting the intersection formed by the two edges of the specific plane as the two-dimensional coordinate origin, and defining the straight line formed by one edge as the X-axis; drawing a perpendicular line to the defined X-axis as the Y-axis of the two-dimensional coordinate system, determining another edge point as the next straight line of the two-dimensional coordinate system, and using this two-dimensional coordinate system to define the two-dimensional position information of the remaining feature points respectively; the subsequent measurement quasi-coordinate system definition remains unchanged; if a two-dimensional coordinate system is defined for a plane feature point, selecting two feature points, one point is defined as the two-dimensional coordinate origin, and the connecting line is used as the X-axis; drawing a perpendicular line to the defined X-axis as the Y-axis of the two-dimensional coordinate system, and determining the coordinates of the third feature point of the three feature points in the two-dimensional coordinate system;
step 5: under the two-dimensional coordinate system established in step 4, using image processing technology, according to the image obtained by the feature detection and recognition component, determining the location of the centroid of the light spot formed by the intersection of the three laser beams emitted by the laser on the plane area of the target to be measured; the two-dimensional coordinates based on the target board system coordinate system are recorded as:
$$P 01 : ( x 01 , y 01 ) , P 02 : ( x 02 , y 02 ) , P 03 : ( x 03 , y 03 ) ;$$
step 6: using the equivalent space straight line equation established in step 1 and the position coordinates obtained in step 5, and the principle that the lengths of the same space line segments are equal in coordinate systems with different proportional factors, calculating the spatial coordinates of the centroid of the light spots where the laser beams emitted by the three lasers intersect the plane area of the target to be measured; the spatial coordinates are defined as the spatial coordinates of the centroid of the three light spots of the target to be measured, which are recorded as: Pq01: (xq01, yq01, zq01), Pq02: (xq02, yq02, zq02), Pq03: (xq03, yq03, zq03);
the specific calculation process is as follows:
according to the principle that the length of space line segments is equal:
$$( xq 01 - xq 02 ) \hat{} 2 + ( yq 01 - yq 02 ) \hat{} 2 + ( zq 01 - zq 02 ) \hat{} 2 = ( x 02 - x 01 ) \hat{} 2 + ( y 02 - y 01 ) \hat{} 2 ;$$
$$( xq 03 - xq 02 ) \hat{} 2 + ( yq 03 - yq 02 ) \hat{} 2 + ( zq 03 - zq 02 ) \hat{} 2 = ( x 02 - x 03 ) \hat{} 2 + ( y 02 - y 03 ) \hat{} 2 ;$$
$$( xq 03 - xq 01 ) \hat{} 2 + ( yq 03 - yq 01 ) \hat{} 2 + ( zq 03 - zq 01 ) \hat{} 2 = ( x 01 - x 03 ) \hat{} 2 + ( y 01 - y 03 ) \hat{} 2 ;$$
combined with the three laser fitting space straight line equations, the spatial coordinates of any three points in the plane area of the target to be measured based on the laser emission reference coordinate system can be calculated, Pq01: (xq01, yq01, zq01), Pq02: (xq02, yq02, zq02), Pq03: (xq03, yq03, zq03);
step 8: the coordinates of the three light spots in the target board coordinate system are P01: (x01, y01, 0), P02: (x02, y02, 0), and P03: (x03, y03, 0); by using the BURSA principle (a method for coordinate transformation), the coordinates of the common points in the two coordinate systems can be solved to obtain the position translation and attitude deviation in the two coordinate systems;
$$[ \begin{matrix}{X}_{Ti} - {X}_{i} \\ {Y}_{Ti} - {Y}_{i} \\ {Z}_{Ti} - {Z}_{i}\end{matrix} ] = [ \begin{matrix}1 & 0 & 0 & {X}_{i} & 0 & - {Z}_{i} & {Y}_{i} \\ 0 & 1 & 0 & {Y}_{i} & {Z}_{i} & 0 & - {X}_{i} \\ 0 & 0 & 1 & {Z}_{i} & - {Y}_{i} & {X}_{i} & 0\end{matrix} ] * [ \begin{matrix}Δ X \\ Δ Y \\ Δ Z \\ k \\ {ε}_{X} \\ {ε}_{Y} \\ {ε}_{Z}\end{matrix} ]$$
(XTi, YTi, ZTi) are the three-dimensional coordinates of the three light spots in the laser emission reference coordinate system, (Xi, Yi, Zi) are the three-dimensional coordinates based on the target board system coordinate system (Zi=0 is defined); (ΔX, ΔY, ΔZ)) are the position translations of the emission and target coordinate systems, k is the calculation scale factor of the two coordinate systems, and (εX, εY, εZ) are the attitude deviation angles of the emission and target coordinate systems;
step 9: repeating steps 3-8, and using the position translation and attitude deviation angle of the target board coordinate system relative to the emission reference coordinate system solved under different attitudes to obtain the target's three-degree-of-freedom position information and three-degree-of-freedom attitude information;
step 10: defining an edge of the target board as the X-axis of the target board system coordinate system, defining the corner point of this edge and the adjacent edge as the origin, taking the plane of the target board as the XOY plane, and the direction perpendicular to the plane of the target board as the Z-axis to establish the target board system coordinate system;
step 11: defining the laser beams emitted by the three lasers on the target board system as L₅, L₆, and L₇ respectively;
step 12: taking the laser beam L₅ as an example, the rotation matrix R and translation matrix T between the target board system coordinate system and the laser emission system coordinate system are obtained by the three-dimensional structured light method to solve the spatial straight line equation of laser beam L₅ in the laser emission system coordinate system:
the conversion relationship between the target board coordinate system and the laser emission system coordinate system is as follows:
$$[ \begin{matrix}{X}_{2} \\ {Y}_{2} \\ {Z}_{2}\end{matrix} ] = R * [ \begin{matrix}{X}_{1} \\ {Y}_{1} \\ {Z}_{1}\end{matrix} ] + [ \begin{matrix}{t}_{1} \\ {t}_{2} \\ {t}_{3}\end{matrix} ]$$
wherein
$$[ \begin{matrix}{X}_{1} \\ {Y}_{1} \\ {Z}_{1}\end{matrix} ]$$
represents the coordinates in the target board coordinate system, and
$$[ \begin{matrix}{X}_{2} \\ {Y}_{2} \\ {Z}_{2}\end{matrix} ]$$
represents the coordinates in the laser emission system coordinate system;
R is a 3×3 rotation matrix, which describes the rotation relationship between the target board coordinate system and the laser emission system coordinate system:
$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$
T is the translation vector, which describes the translation relationship from the target board coordinate system to the laser emission system coordinate system:
$$T = [ \begin{matrix}{t}_{1} \\ {t}_{2} \\ {t}_{3}\end{matrix} ]$$
defining the spatial straight line equation L₅ of the laser beam in the target board coordinate system as follows:
$${X}_{1} = {a}_{1} {s}_{1} + {b}_{1}$$
$${Y}_{1} = {c}_{1} {s}_{1} + {d}_{1}$$
$${Z}_{1} = {s}_{1}$$
converting L₅ in the target board coordinate system to the laser emission system coordinate system as follows:
$$[ \begin{matrix}{X}_{2} \\ {Y}_{2} \\ {Z}_{2}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{a}_{1} {S}_{1} + {b}_{1} \\ {c}_{1} {S}_{1} + {d}_{1} \\ {S}_{1}\end{matrix} ] + [ \begin{matrix}{t}_{1} \\ {t}_{2} \\ {t}_{3}\end{matrix} ]$$
the three coordinate components are:
$${X}_{2} = ( {r}_{11} {a}_{1} + {r}_{12} {c}_{1} + {r}_{13} ) {S}_{1} + ( {r}_{11} {b}_{1} + {r}_{12} {d}_{1} + {t}_{1} )$$
$${Y}_{2} = ( {r}_{21} {a}_{1} + {r}_{22} {c}_{1} + {r}_{23} ) {S}_{1} + ( {r}_{21} {b}_{1} + {r}_{22} {d}_{1} + {t}_{2} )$$
$${Z}_{2} = ( {r}_{31} {a}_{1} + {r}_{32} {c}_{1} + {r}_{33} ) {S}_{1} + ( {r}_{31} {b}_{1} + {r}_{32} {d}_{1} + {t}_{3} )$$
solving the equation of the laser beam L₅ in the laser emission system coordinate system as follows:
$${X}_{2} = {A}_{2} {S}_{1} + {B}_{2}$$
$${Y}_{2} = {C}_{2} {S}_{1} + {D}_{2}$$
$${Z}_{2} = {E}_{2} {S}_{1} + {F}_{2}$$
wherein,
$${A}_{2} = {r}_{11} {a}_{1} + {r}_{12} {c}_{1} + {r}_{13} , {B}_{2} = {r}_{11} {b}_{1} + {r}_{12} {d}_{1} + {t}_{1}$$
$${C}_{2} = {r}_{21} {a}_{1} + {r}_{22} {c}_{1} + {r}_{23} , {D}_{2} = {r}_{21} {b}_{1} + {r}_{22} {d}_{1} + {t}_{2}$$
$${E}_{2} = {r}_{31} {a}_{1} + {r}_{32} {c}_{1} + {r}_{33} , {F}_{2} = {r}_{31} {b}_{1} + {r}_{32} {d}_{1} + {t}_{3}$$
step 13: defining the reflector plane as the plane with Z=0 in the laser emission system coordinate system, then the equation of the spatial straight line after the laser beam L₅ is reflected by the reflector is
$${L}_{5}^{′} :$$
$${X}_{2}^{′} = {X}_{2} = {A}_{2} {S}_{1} + {B}_{2}$$
$${Y}_{2}^{′} = {Y}_{2} = {C}_{2} {S}_{1} + {D}_{2}$$
$${Z}_{2}^{′} = - {Z}_{2} = - ( {E}_{2} {S}_{1} + {F}_{2} )$$
step 14: using the stereo structured light method to solve the equation of the target board plane in the laser emission system coordinate system; the target board plane M₁ is:
$${M}_{1} : {A}_{3} x + {B}_{3} y + {C}_{3} z + {D}_{3} = 0$$
step 15: solving the intersection coordinates P₅(x₅, y₅, z₅) of the laser beam
$${L}_{5}^{′}$$
after being reflected by the reflector and the target board plane M₁;
wherein the intersection point P₅(x₅, y₅, z₅) satisfies the spatial straight line equation of the laser beam
$${L}_{5}^{′} ,$$
$${x}_{5} = {X}_{2}^{′} = {A}_{2} {S}_{1} + {B}_{2}$$
$${y}_{5} = {Y}_{2}^{′} = {C}_{2} {S}_{1} + {D}_{2}$$
$${z}_{5} = {Z}_{2}^{′} = - ( {E}_{2} {S}_{1} + {F}_{2} )$$
substituting x₅, y₅, z₅ into the target plane equation A₃x+B₃y+C₃z+D₃=0:
$${A}_{3} ( {A}_{2} {S}_{1} + {B}_{2} ) + {B}_{3} ( {C}_{2} {S}_{1} + {D}_{2} ) + {C}_{3} ( - ( {E}_{2} {S}_{1} + {F}_{2} ) ) + {D}_{3} = 0$$
after expansion:
$$( {A}_{3} {A}_{2} + {B}_{3} {C}_{2} - {C}_{3} {E}_{2} ) {S}_{1} + ( {A}_{3} {B}_{2} + {B}_{3} {D}_{2} - {C}_{3} {F}_{2} + {D}_{3} ) = 0$$
after solving the parameter S₁, substituting it into the intersection coordinate formula to get the intersection coordinates:
$${x}_{5} = - \frac{{A}_{2} {k}_{2}}{{k}_{1}} + {B}_{2}$$
$${y}_{5} = - \frac{{C}_{2} {k}_{2}}{{k}_{1}} + {D}_{2}$$
$${z}_{5} = \frac{{E}_{2} {k}_{2}}{{k}_{1}} - {F}_{2}$$
wherein:
$${k}_{1} = {A}_{3} {A}_{2} + {B}_{3} {C}_{2} - {C}_{3} {E}_{2}$$
$${k}_{2} = {A}_{3} {B}_{2} + {B}_{3} {D}_{2} - {C}_{3} {F}_{2} + {D}_{3}$$
step 16: using the stereo structured light method to solve the pose change of the target board under the laser emission system as Δx, Δy, Δz, α, β, γ;
step 17: according to the pose change in step 16, Δx, Δy, Δz, α, β, γ, the rotation matrix R′ and translation matrix T′ representing the pose change of the target board system in the laser emission system coordinate system are:
$${R}^{′} = [ \begin{matrix}cos β cos γ & cos γ sin α sin β - cos α sin γ & sin α sin γ + cos αcos γ sin β \\ cos β sin γ & cos α cos γ + sin α sin β sin γ & cos α sin β sin γ - cos γsin α \\ - sin β & cos βsin α & cos αcos β\end{matrix} ]$$
$${T}^{′} = [ \begin{matrix}Δ x \\ Δ y \\ Δ z\end{matrix} ]$$
step 18: according to the rotation matrix R′ and translation matrix T′ obtained in step 17, calculating the spatial straight line equation
$${L}_{5}^{′′}$$
of the laser beam L₅ after the pose change:
substituting the linear equation (X₂, Y₂, Z₂) of the laser beam L₅ into the rotation and translation formulas:
$$[ \begin{matrix}{X}_{3} \\ {Y}_{3} \\ {Z}_{3}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \cdot [ \begin{matrix}{A}_{2} {S}_{1} + {B}_{2} \\ {C}_{2} {S}_{1} + {D}_{2} \\ {E}_{2} {S}_{1} + {F}_{2}\end{matrix} ] + [ \begin{matrix}Δ x \\ Δ y \\ Δ z\end{matrix} ]$$
the linear equation of the laser beam space after the pose change is:
$${X}_{3} = {A}_{3} {S}_{1} + {B}_{3}$$
$${Y}_{3} = {C}_{3} {S}_{1} + {D}_{3}$$
$${Z}_{3} = {E}_{3} {S}_{1} + {F}_{3}$$
wherein:
$${A}_{3} = {r}_{11} {A}_{2} + {r}_{12} {C}_{2} + {r}_{13} {E}_{2} , {B}_{3} = {r}_{11} {B}_{2} + {r}_{12} {D}_{2} + {r}_{13} {F}_{2} + Δ x$$
$${C}_{3} = {r}_{21} {A}_{2} + {r}_{22} {C}_{2} + {r}_{23} {E}_{2} , {D}_{3} = {r}_{21} {B}_{2} + {r}_{22} {D}_{2} + {r}_{23} {F}_{2} + Δ y$$
$${E}_{3} = {r}_{31} {A}_{2} + {r}_{32} {C}_{2} + {r}_{33} {E}_{2} , {F}_{3} = {r}_{31} {B}_{2} + {r}_{32} {D}_{2} + {r}_{33} {F}_{2} + Δ z$$
step 19: the spatial straight line equation of the laser beam
$${L}_{5}^{′′}$$
after being reflected by the reflector becomes
$${L}_{5}^{′′′} :$$
$${X}_{3} = {A}_{3} {S}_{1} + {B}_{3}$$
$${Y}_{3} = {C}_{3} {S}_{1} + {D}_{3}$$
$${Z}_{3} = - {E}_{3} {S}_{1} - {F}_{3}$$
step 20: after the pose change of the target board plane, the plane equation of the target board plane M₁ in the laser emission system coordinate system becomes:
$${M}_{1}^{′} : {A}_{3}^{′} x + {B}_{3}^{′} y + {C}_{3}^{′} z + {D}_{3}^{′} = 0$$
wherein:
$$[ \begin{matrix}{A}_{3}^{′} \\ {B}_{3}^{′} \\ {C}_{3}^{′}\end{matrix} ] = {R}^{T} \cdot [ \begin{matrix}{A}_{3} \\ {B}_{3} \\ {C}_{3}\end{matrix} ] , {D}_{3}^{′} = {D}_{3} - ( {A}_{3}^{′} Δ x + {B}_{3}^{′} Δ y + {C}_{3}^{′} Δ z )$$
step 21: solving the intersection coordinates
$${P}_{5}^{′} ( {x}_{5}^{′} , {y}_{5}^{′} , {z}_{5}^{′} )$$
of the laser beam
$${L}_{5}^{′′′}$$
and the plane
$${M}_{1}^{′}$$
as follows:
$${x}_{5}^{′} = - \frac{{A}_{3} {K}_{2}^{′}}{{K}_{1}^{′}} + {B}_{3}$$
$${y}_{5}^{′} = - \frac{{C}_{3} {K}_{2}^{′}}{{K}_{1}^{′}} + {D}_{3}$$
$${z}_{5}^{′} = \frac{{E}_{3} {K}_{2}^{′}}{{K}_{1}^{′}} - {F}_{3}$$
wherein:
$${K}_{1}^{′} = {A}_{3}^{′} {A}_{3} + {B}_{3}^{′} {C}_{3} - {C}_{3}^{′} {E}_{3}$$
$${K}_{2}^{′} = {A}_{3}^{′} {B}_{3} + {B}_{3}^{′} {D}_{3} - {C}_{3}^{′} {F}_{3} + {D}_{3}^{′}$$
step 22: according to the camera detector, the distance between the laser beam and the light spot on the target board plane after the pose change is ΔL₁;
step 23: combining steps 16 and 21 to solve the intersection coordinates P₅(x₅, y₅, z₅) and
$${P}_{5}^{′} ( {x}_{5}^{′} , {y}_{5}^{′} , {z}_{5}^{′} )$$
before and after the pose change and the distance ΔL₁ in step 23 to get:
$$Δ {L}_{1} = {\{ \begin{matrix}{[ ( - \frac{{A}_{2} {k}_{2}}{{k}_{1}} + {B}_{2} ) - ( - \frac{{A}_{3} {k}_{2}^{′}}{{k}_{1}^{′}} + {B}_{2} ) ]}^{2} + \\ {[ ( C - \frac{{C}_{2} {k}_{2}}{{k}_{1}} + {D}_{2} ) - ( - \frac{{C}_{3} {k}_{2}^{′}}{{k}_{1}^{′}} + {D}_{3} ) ]}^{2} + \\ {[ ( \frac{{E}_{2} {k}_{3}}{{k}_{1}} - {F}_{2} ) - ( \frac{{E}_{3} {k}_{1}^{′}}{{k}_{1}^{′}} - {F}_{3} ) ]}^{2}\end{matrix} \}}^{\frac{1}{2}}$$
the relationship can be written as:
$${\{ \begin{matrix}{[ ( - \frac{{A}_{2} {k}_{2}}{{k}_{1}} + {B}_{2} ) - ( - \frac{{A}_{3} {k}_{2}^{′}}{{k}_{1}} + {B}_{2} ) ]}^{2} + \\ {[ ( C - \frac{{C}_{2} {k}_{2}}{{k}_{1}} + {D}_{2} ) - ( - \frac{{C}_{3} {k}_{2}^{′}}{{k}_{1}^{′}} + {D}_{3} ) ]}^{2} + \\ {[ ( \frac{{E}_{2} {k}_{3}}{{k}_{1}} - {F}_{2} ) - ( \frac{{E}_{3} {k}_{1}^{′}}{{k}_{1}^{′}} - {F}_{3} ) ]}^{2}\end{matrix} \}}^{\frac{1}{2}} - Δ {L}_{1} = 0$$
the above relationship can be written as a form containing three unknowns α, β, and γ:
$${F}_{1} ( α , β , γ ) = 0$$
step 24: repeating steps 12-23 to obtain the equations of laser beams L₆, L₇ and ΔL₂, ΔL₃ with respect to α, β, γ:
$${F}_{2} ( α , β , γ ) = 0$$
$${F}_{3} ( α , β , γ ) = 0$$
step 25: transforming the equations in steps 23-24 into:
$$F ( α , β , γ ) = {F}_{1} + {F}_{2} + {F}_{3} = 0$$
step 26: using the Gauss-Newton nonlinear least squares algorithm to solve the angles α, β, γ; finally, obtaining the pose information of the array light spot feature target component relative to the laser emission standard;
step 27: repeating steps 3-26, and using the position translation and attitude deviation angle of the target board coordinate system relative to the emission reference coordinate system solved under different poses to obtain the three-degree-of-freedom position information and three-degree-of-freedom attitude information of the target, and feeding back the six-degree-of-freedom array light spot feature target component pose information, i.e. the parallel mechanism moving platform pose information, to the six-degree-of-freedom parallel mechanism structure in real time for motion adjustment;
step 28: measuring the pose information and converting it into the pose adjustment information of the six-degree-of-freedom parallel mechanism structure:
the parallel mechanism base coordinate system {B} is located on the parallel mechanism fixed platform; the parallel mechanism base coordinate system {B} is the reference datum of other coordinate systems; the moving platform coordinate system {P} is located on the parallel mechanism moving platform; {M} is the laser emission reference coordinate system of the measurement system; {T} is the target board coordinate system; the relative position of the target board coordinate system and the moving platform coordinate system is fixed;
the transformation relationship between coordinate systems is expressed by the homogeneous transformation matrix; the pose transformation relationship from the moving platform coordinate system {P} to the base coordinate system {B} is represented by
$${T}_{P}^{B} ;$$
similarly, the pose transformation from the target board coordinate system {T} to the base coordinate system {B} is represented by
$${T}_{T}^{B} ,$$
and the pose transformation from the target board coordinate system {T} to the moving platform coordinate system {P} is represented by
$${T}_{T}^{P} ;$$
the pose transformation matrix is:
$${T}_{P}^{B} = [ \begin{matrix}{R}_{P}^{B} & {P}_{P}^{B} \\ 0 & 1\end{matrix} ] , {T}_{T}^{B} = [ \begin{matrix}{R}_{T}^{B} & {P}_{T}^{B} \\ 0 & 1\end{matrix} ] , {T}_{T}^{P} = [ \begin{matrix}{R}_{T}^{P} & {P}_{T}^{P} \\ 0 & 1\end{matrix} ] \qquad ( 1 )$$
the above coordinate system transformation relationship satisfies:
$${T}_{T}^{B} = {T}_{P}^{B} {T}_{T}^{P} \qquad ( 2 )$$
combined with the pose transformation matrix, it can be expressed as:
$$[ \begin{matrix}{R}_{T}^{B} & {P}_{T}^{B} \\ 0 & 1\end{matrix} ] = [ \begin{matrix}{R}_{P}^{B} & {P}_{P}^{B} \\ 0 & 1\end{matrix} ] [ \begin{matrix}{R}_{T}^{P} & {P}_{T}^{P} \\ 0 & 1\end{matrix} ] \qquad ( 4 )$$
it can be obtained from formula 2 that:
$${R}_{T}^{B} = {R}_{P}^{B} {R}_{T}^{P} \qquad ( 5 )$$
$${P}_{T}^{B} = {R}_{P}^{B} {P}_{T}^{P} + {P}_{P}^{B} \qquad ( 6 )$$
similarly, in the laser emission reference coordinate system, (5) and (6) can be expressed as
$${R}_{T}^{B} = {R}_{M}^{B} {R}_{T}^{M} \qquad ( 7 )$$
$${P}_{T}^{B} = {R}_{M}^{B} {P}_{T}^{M} + {P}_{M}^{B} \qquad ( 8 )$$
combining formulas (5)-(8) to obtain the rotation matrix and translation matrix of the six-degree-of-freedom parallel mechanism structure:
$${R}_{P}^{B} = {R}_{M}^{B} {{R}_{T}^{M} ( {R}_{T}^{P} )}^{- 1} \qquad ( 9 )$$
$${P}_{P}^{B} = {R}_{M}^{B} {P}_{T}^{M} + {P}_{M}^{B} - {R}_{P}^{B} {P}_{T}^{P} \qquad ( 10 )$$
the measured pose information can be converted into the pose information of the six-degree-of-freedom parallel mechanism structure through formulas (9) and (10), where
$${R}_{T}^{M} and {P}_{T}^{M}$$
are the rotation matrix and translation matrix calculated from the three-degree-of-freedom pose information and the three-degree-of-freedom pose information obtained in step 27,
$${R}_{M}^{B} , {R}_{T}^{P} , {P}_{M}^{B} , and {P}_{T}^{P}$$
are fixed values that can be obtained based on the measurement results of multiple pose points.
